(19) United States
(12) Patent Application Publication
(10) Pub. No.: US 2012/0086917 A1
(43) Pub. Date: Apr. 12, 2012

(54) OPTICAL UNIT, PROJECTION DISPLAY APPARATUS, AND OPTICAL DIFFUSER

(75) Inventors: Michihiro Okuda, Hirakata-City (JP); Azusa Ozaki, Sapporo-City (JP); Yuki Tanohata, Nishinomiya-City (JP)

(73) Assignee: SANYO ELECTRIC CO., LTD., Moriguchi-shi, Osaka (JP)

(21) Appl. No.: 13/376,704

(22) PCT Filed: Sep. 29, 2010
(86) PCT No.: PCT/JP2010/066971

§ 371 Date: Dec. 7, 2011

(30) Foreign Application Priority Data
Sep. 29, 2009 (JP) 2009-224666
Oct. 9, 2009 (JP) 2009-235648
Feb. 25, 2010 (JP) 2010-041051
Feb. 26, 2010 (JP) 2010-042957

(51) Int. Cl. G03B 21/14; G02B 27/12; G02B 5/02

(52) U.S. Cl. 353/38; 353/85; 359/599; 359/619

(57) ABSTRACT

Disclosed is a projection display apparatus which is provided with: a light source (110) which emits light having coherency; a light modulation element (500), which modules the light emitted from the light source; and a projection unit (150) which projects, to a projection plane, the light emitted from the light modulation element. The projection display apparatus is also provided with a speckle noise reducing element (600) provided between the light source and the light modulation element, and a control unit which controls first mode and second mode. The control unit controls the speckle noise reducing element so that speckles are reduced in the first mode compared with those in the second mode.

### TECHNICAL FIELD

The present invention relates to au optical unit provided with a light source that emits light having coherency, a projection display apparatus, and an optical diffuser that diffuses light having coherency.

### BACKGROUND ART

Conventionally, there has been disclosed a projection display apparatus provided with a light source, an imager that modulates light that emitted from the light source, and a projection unit that projects light emitted from the imager onto a projection surface.

In recent years, in order to mainly achieve the high luminance of image light, it has been attempted to use a laser light source as a light source of a projection display apparatus.

Here, since a laser light beam emitted from the laser light source has coherency, speckle noise may be a problem. The speckle noise is generated when image light emitted from a projection unit is scattered on a projection surface and scattered light beams interfere with each other. In addition, as a method for reducing the speckle noise, the following methods have been proposed.

According to a first method, a laser light beam is diffused by a disk-shaped diffusion plate that rotates about a rotating axis parallel to a travel direction of the laser light beam (for example, refer to Patent Document 1). According to a second method, the laser light beam is diffused by two diffusion plates (for example, refer to Patent Document 2).

In the first method and the second method, the diffusion plate is used in order to reduce the speckle noise. However, if the laser light beam is diffused by the diffusion plate, the luminance of light projected onto a projection surface is reduced. That is, a speckle noise reduction effect and the luminance of image displayed on the projection surface have a trade-off relation.

### PRIOR ART DOCUMENT

### Patent Document

Patent Document 1: Japanese Unexamined Patent Application Publication No. 2008-122823
Patent Document 2: Japanese Unexamined Patent Application Publication No. 2008-134269

### SUMMARY OF THE INVENTION

A projection display apparatus according to a first feature includes a light source (light source unit 110) that emits light having coherency, an imager (DMD 500) that modulates the light emitted from the light source, and a projection unit (projection unit 150) that projects light emitted from the imager onto a projection surface. The projection display apparatus includes: a speckle noise reduction element provided between the light source and the imager; and a control unit (control unit 800) that controls a first mode and a second mode. The control unit controls the speckle noise reduction element so that speckle noise is reduced in the first mode than in the second mode.

A projection display apparatus according to a second feature includes a light source (light source unit 110) that emits light having coherency, an imager (DMD 500) that modulates the light emitted from the light source, and a projection unit (projection unit 150) that projects light emitted from the imager onto a projection surface. The projection display apparatus includes an optical diffuser (optical diffuser 600) provided between the light source and the imager, that diffuses the light emitted from the light source and transmit the light emitted from the light source; and a control unit (control unit 800) that controls a first mode and a second mode. The control unit controls the optical diffuser to diffuse the light emitted from the light source in the first mode, with a diffusion degree higher than a diffusion degree in the second mode.

In the second feature, the optical diffuser has a plurality of diffusion surfaces in a travel direction of the light emitted from the light source. The control unit controls the optical diffuser so that the plurality of diffusion surfaces operate in different operation patterns.

In the second feature, the optical diffuser includes: a first rotating member that rotates about a first rotating axis; a second rotating member that rotates about a second rotating axis parallel to the first rotating axis; and a belt-like diffusion sheet wound around the first rotating member and the second rotating member in an endless loop. The belt-like diffusion sheet constitutes two diffusion surfaces in the travel direction of the light emitted from the light source. The control unit controls the optical diffuser so that the two diffusion surfaces move in a reverse direction according to rotation of the first rotating member and the second rotating member.

In the second feature, the control unit controls the optical diffuser so that when one of the plurality of diffusion surfaces stops, another diffusion surface moves.

In the second feature, the optical diffuser includes: a first diffusion plate; and a second diffusion plate. The control unit controls the optical diffuser so that the first diffusion plate and the second diffusion plate vibrate along directions different from each other.

In the second feature, the optical diffuser has a plurality of diffusion areas with different degrees of diffusion. The control unit controls the optical diffuser to diffuse the light emitted from the light source in the second mode, using a diffusion area having a diffusion degree lower than a diffusion degree of a diffusion area used in the first mode.

An optical diffuser according to a third feature diffuses light having coherency and transmit the light having coherency. The optical diffuser includes: a first rotating member that rotates about a first rotating axis; a second rotating member that rotates about a second rotating axis parallel to the first rotating axis; and a belt-like diffusion sheet wound around the first rotating member and the second rotating member in an endless loop. The belt-like diffusion sheet constitutes two diffusion surfaces that move in a reverse direction.

A projection display apparatus according to a fourth feature includes a light source (light source unit 110) that emits light having coherency, an imager (DMD 500) that modulates the light emitted from the light source, a projection unit (projection unit 150) that projects light emitted from the imager onto a projection surface, and a relay optical unit (lens 21W, lens 23, and lens 40, for example) that relays the light emitted from the light source so that the imager is illuminated with the light emitted from the light source. The projection display apparatus includes an uniformization optical element (optical diffuser 600, for example) that uniformizes spatial distribution of light intensity on an exit pupil surface of the projection unit.

In the fourth feature, the uniformization optical element is the optical diffuser provided between the light source and the imager to diffuse the light emitted from the light source while transmitting the light emitted from the light source. The optical diffuser includes a center area having an optical axis center of the light emitted from the light source, and a peripheral area provided around the center area. A diffusion degree of the center area is larger than a diffusion degree of the peripheral area.

In the fourth feature, the projection display apparatus includes: a control unit (control unit 800) that controls the uniformization optical element so that the uniformization optical element operates in a predetermined operation pattern.

An optical diffuser according to a fifth feature diffuses light having coherency and has a diffusion area through which the light having coherency passes. The diffusion area includes a center area having an optical axis center of the light having coherency and a peripheral area provided around the center area. A diffusion degree of the center area is larger than a diffusion degree of the peripheral area.

An optical unit (for example, a speckle noise reduction element 20R) according to a sixth feature includes: a pair of lens arrays (incident-side micro lens array 310 and exit-side micro lens array 312); and a vibration applying unit that periodically moves the pair of lens arrays.

Herein, the vibration includes any movement that periodically changes in a predetermined range, and includes a rotation and a swing, for example, in addition to a linear movement.

According to this mode, it is possible to reduce speckle noise, and also possible to prevent an increase of a divergence angle at which light enters.

In the sixth feature, the pair of lens arrays includes: a first lens array (incident-side micro lens array 310) with a focal distance f; and a second lens array (exit-side micro lens array 312) with a focal distance f′, the focal distance f and the focal distance f′ satisfies f≦f′. When a medium with an absolute refractive index n is interposed between the first lens array and the second lens array, an interval between the first lens array and the second lens array is approximately (f+f′)/n.

That is, if the first lens array and the second lens arrays have the same focal distance f, then these arrays suffice to have an interval of approximately 2f/n, and if there is air between the first lens array and the second lens array, these arrays suffice to have an interval of approximately f+f′.

A projection display apparatus (projection display apparatus 100) according to a seventh feature includes: a light source unit (light source unit 110) configured by a coherent light source; an optical unit (for example, a speckle noise reduction element 20R) that vibrates in a direction approximately perpendicular to an optical axis of light emitted from the light source unit; an imager (for example, DMD 500R) that modulates the light emitted from the light source unit; and a projection unit (projection unit 150) that projects the light modulated by the imager. The optical unit includes a pair of lens arrays (an incident-side micro lens array 310 and an exit-side micro lens array 312).

According to the seventh feature, it is possible to reduce speckle noise related to a projection display apparatus using a coherent light source, thereby reducing light loss due to an increase in light divergence angle.

In the seventh feature, in at least a lens array arranged on an incidence side, of the pair of lens arrays, a diameter d and a focal distance f of each lens are set so that a condition of tan θ<d/4f is satisfied, where θ denotes a divergence angle of light incident upon the optical unit.

### BRIEF DESCRIPTION OF THE DRAWINGS

FIG. 1 is a diagram illustrating a schematic configuration of a projection display apparatus 100 according to a first embodiment.

FIG. 2 is a diagram illustrating a schematic configuration of the projection display apparatus 100 according to the first embodiment.

FIG. 3 is a diagram illustrating an optical configuration of the projection display apparatus 100 according to the first embodiment.

FIG. 4 is a diagram illustrating a first configuration example of an optical diffuser 600 according to the first embodiment.

FIG. 5 is a diagram illustrating a second configuration example of the optical diffuser 600 according to the first embodiment.

FIG. 6 is a diagram illustrating a third configuration example of the optical diffuser 600 according to the first embodiment.

FIG. 7 is a block diagram illustrating a control unit 800 according to the first embodiment.

FIG. 8 is a diagram explaining an external interface 810 according to the first embodiment.

FIG. 9 is a diagram explaining the external interface 810 according to the first embodiment.

FIG. 10 is a diagram explaining the external interface 810 according to the first embodiment.

FIG. 11 is a diagram illustrating the optical diffuser 600 according to a first modification.

FIG. 12 is a diagram illustrating the optical diffuser 600 according to the first modification.

FIG. 13 is a diagram illustrating the optical diffuser 600 according to the first modification.

FIG. 14 is a diagram illustrating the optical diffuser 600 according to a second modification.

FIG. 15 is a diagram illustrating the optical diffuser 600 according to the second modification.

FIG. 16 is a diagram illustrating the optical diffuser 600 according to the second modification.

FIG. 17 is a diagram illustrating the optical diffuser 600 according to a third modification.

FIG. 18 is a diagram illustrating the optical diffuser 600 according to the third modification.

FIG. 19 is a diagram illustrating a schematic configuration of the projection display apparatus 100 according to a second embodiment.

FIG. 20 is a diagram illustrating a schematic configuration of the projection display apparatus 100 according to the second embodiment.

FIG. 21 is a diagram illustrating an optical configuration of the projection display apparatus 100 according to the second embodiment.

FIG. 22 is a diagram illustrating a first configuration example of the optical diffuser 600 according to the second embodiment.

FIG. 23 is a diagram illustrating a second configuration example of the optical diffuser 600 according to the second embodiment.

FIG. 24 is a block diagram illustrating the control unit 800 according to the second embodiment.

FIG. 25 is a diagram explaining spatial distribution of light intensity according to a conventional technology.

FIG. 26 is a diagram explaining spatial distribution of light intensity according to the conventional technology.

FIG. 27 is a diagram explaining spatial distribution of light intensity according to the second embodiment.

FIG. 28 is a diagram explaining spatial distribution of light intensity according to the second embodiment.

FIG. 29 is a perspective view illustrating the projection display apparatus 100 according to a third embodiment.

FIG. 30 is a view in which the projection display apparatus 100 according to the third embodiment is seen from its side.

FIG. 31 is a view in which a projection display apparatus 100 according to the third embodiment is seen from above.

FIG. 32 is a diagram illustrating a light source unit 110 according to the third embodiment.

FIG. 33 is a diagram illustrating a color separation and combination unit 140 and a projection unit 150 according to the third embodiment.

FIG. 34 is a detailed diagram of a speckle noise reduction element according to the third embodiment.

FIG. 35 (a) is a diagram illustrating an optical path of light passing though a speckle noise reduction element according to the third embodiment. FIG. 35 (b) is a diagram illustrating an optical path of light passing though a speckle noise reduction element according to the third embodiment when the speckle noise reduction element has moved upward by vibration, as compared with FIG. 35 (a). FIG. 35 (c) is a diagram illustrating an optical path of light passing though a speckle noise reduction element according to the third embodiment when the speckle noise reduction element has moved downward by vibration, as compared with FIG. 35 (a).

FIG. 36 is a diagram illustrating the color separation and combination unit 140 and the projection unit 150 according to the first modification.

FIG. 37 is a view in which the projection display apparatus 100 according to a fourth embodiment is seen from its side.

### BEST MODES FOR CARRYING OUT THE INVENTION

Next, an embodiment of the present invention will be described with reference to the drawings. The description of the drawings in relation to the following embodiments uses the same or similar reference numerals in relation to the same or similar portion.

It will be appreciated that the drawings are schematically shown and the ratio and the like of each dimension are different from the real ones. Therefore, the specific dimensions, etc., should be determined in consideration of the following explanations. Of course, among the drawings, the dimensional relationship and the ratio are different.

### Overview of First Embodiment

### Configuration of First Embodiment

A projection display apparatus according to a first embodiment includes a light source that emits light having coherency, an imager that modulates light emitted from the light source, and a projection unit that projects light emitted from the imager onto a projection surface. The projection display apparatus includes an optical diffuser provided between the light source and the imager to diffuse the light emitted from the light source while transmitting the light emitted from the light source, and a controller that controls a first mode and a second mode. The controller controls the optical diffuser to diffuse the light emitted from the light source in the first mode, with a diffusion degree higher than a diffusion degree in the second mode.

In the first embodiment, the controller controls the optical diffuser to diffuse the light emitted from the light source in the first mode, with the diffusion degree higher than the diffusion degree in the second mode. That is, in the first mode, since the diffusion degree is higher than the diffusion degree in the second mode, speckle noise is effectively removed. Meanwhile, in the second mode, since the diffusion degree is lower than the diffusion degree in the first mode, luminance reduction is suppressed. That is, it is possible to appropriately achieve speckle noise removal and luminance reduction suppression through mode switching.

### First Embodiment

### Configuration of Projection Display Apparatus

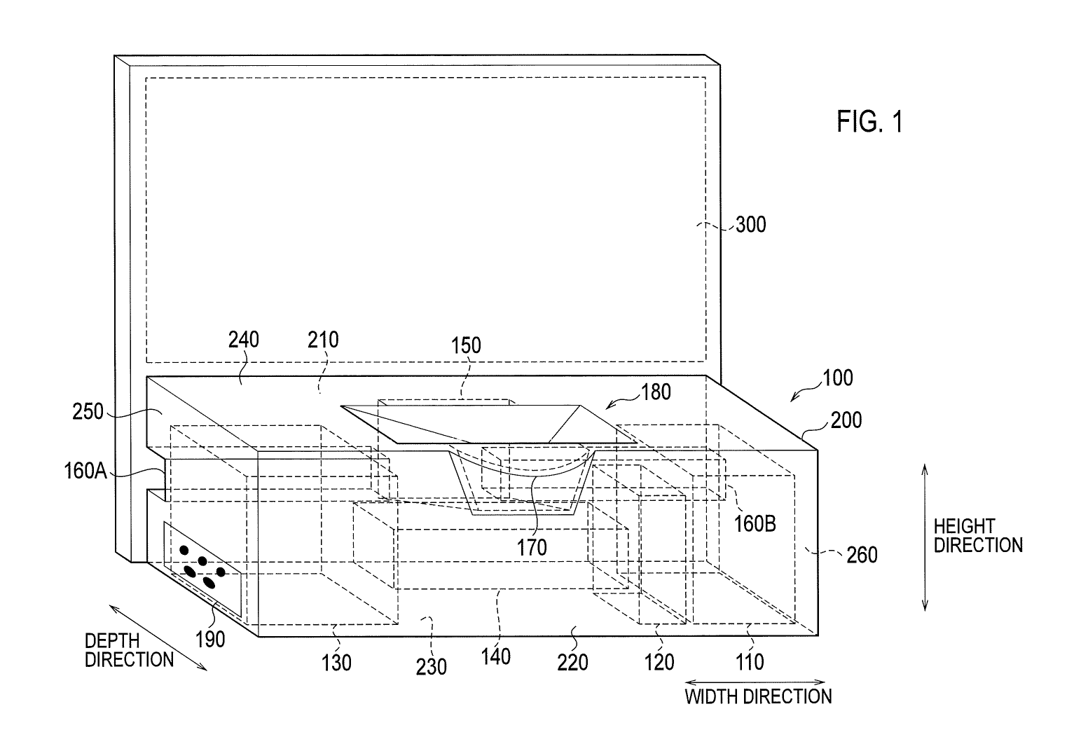

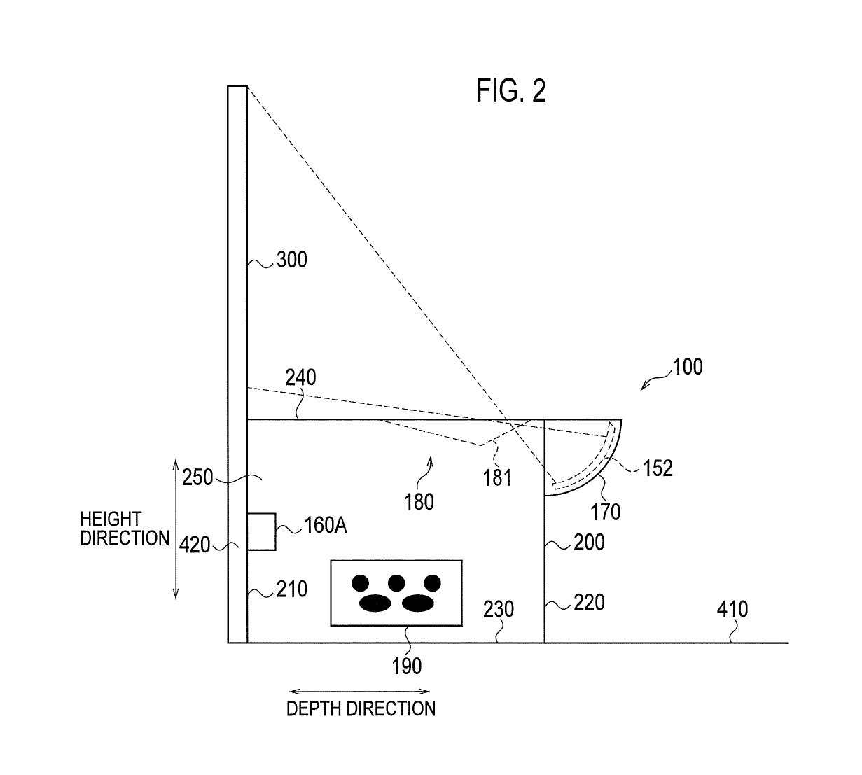

Hereinafter, the configuration of the projection display apparatus according to the first embodiment is described with reference to drawings. FIG. 1 is a perspective view illustrating a projection display apparatus 100 according to the first embodiment. FIG. 2 is a view in which the projection display apparatus 100 according to the first embodiment is seen from its side.

As illustrated in FIG. 1 and FIG. 2, the projection display apparatus 100 includes a housing member 200 and projects image onto a projection surface 300. Hereinafter, the case in which the projection display apparatus 100 projects image light onto the projection surface 300 provided to a wall surface will be described as an example (wall surface projection).

In such a case, the arrangement of the housing member 200 will be called wall surface projection arrangement. Specifically, the projection display apparatus 100 is arranged along a wall surface 420 and a floor surface 410 approximately perpendicular to the wall surface 420.

In the first embodiment, a horizontal direction parallel to the projection surface 300 will be called a “width direction”. A normal direction of the projection surface 300 will be called a “depth direction”. A direction perpendicular to both the width direction and the depth direction will be called a “height direction”.

The housing member 200 has an approximately rectangular parallelepiped shape. The size in the depth direction of the housing member 200 and the size in the height direction of the housing member 200 are smaller than the size in the width direction of the housing member 200. The size in the depth direction of the housing member 200 is approximately the same as a projection distance from a reflection mirror (a concave mirror 152 illustrated in FIG. 2) to the projection surface 300. In the width direction, the size of the housing member 200 is approximately the same as the size of the projection surface 300. In the height direction, the size of the housing member 200 is determined according to an installation position of the projection surface 300.

Specifically, the housing member 200 includes a projection surface-side sidewall 210, a front-side sidewall 220, a bottom plate 230, a top plate 240, a first side surface-side sidewall 250, and a second side surface-side sidewall 260.

The projection surface-side sidewall 210 is a plate-shaped member facing a first arrangement surface (the wall surface 420 in the first embodiment) which is approximately parallel to the projection surface 300. The front-side sidewall 220 is a plate-shaped member provided at an opposite side of the projection surface-side sidewall 210. The bottom plate 230 is a plate-shaped member facing the floor surface 410. The top plate 240 is a plate-shaped member provided at an opposite side of the bottom plate 230. The first side surface-side sidewall 250 and the second side surface-side sidewall 260 are plate-shaped members forming both ends of the housing member 200 in the width direction.

The housing member 200 houses a light source unit 110, a power unit 120, a cooling unit 130, a color separation and combination unit 140, and a projection unit 150. The projection surface-side sidewall 210 has a projection surface-side concave unit 160A and a projection surface-side concave unit 160B. The front-side sidewall 220 has a front-side convex unit 170. The top plate 240 has a top plate concave unit 180. The first side surface-side sidewall 250 has a cable terminal 190.

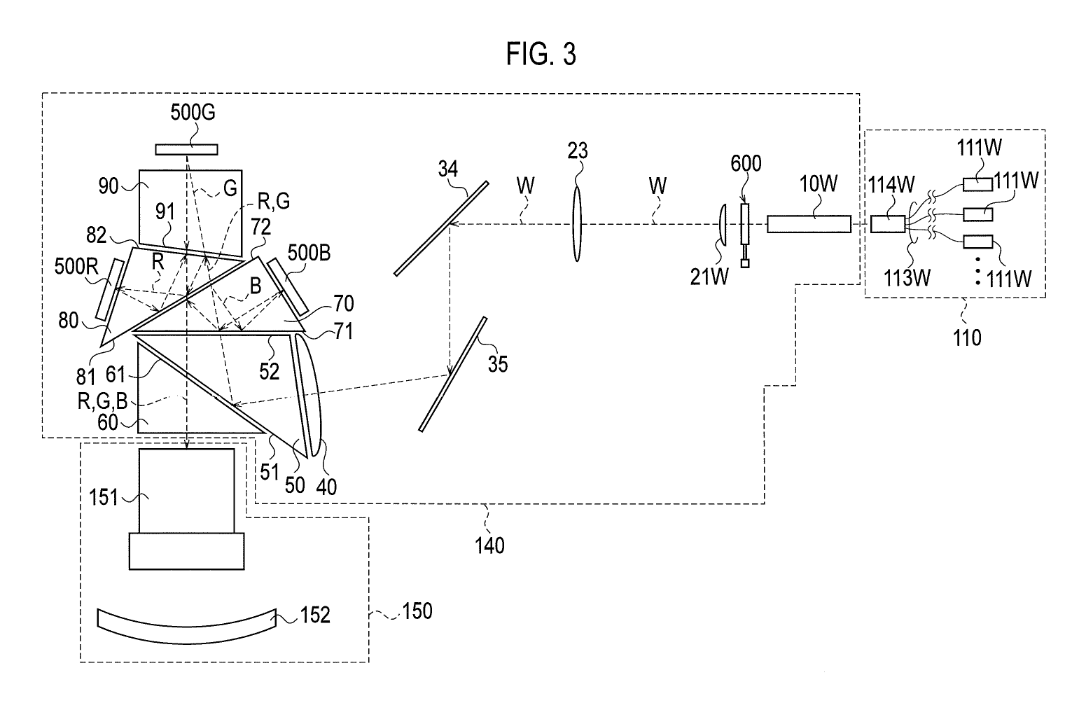

The light source unit 110 is formed of a plurality of light sources (solid light sources 111W illustrated in FIG. 3). Each light source is a semiconductor laser element such as an LD (laser diode). In the first embodiment, the plurality of solid light sources 111W outputs white light beams W having coherency. Details of the light source unit 110 will be given later.

The power unit 120 supplies power to the projection display apparatus 100. For example, the power unit 120 supplies power to the light source unit 110 and the cooling unit 130.

The cooling unit 130 cools the plurality of light sources provided in the light source unit 110. Specifically, the cooling unit 130 cools each light source by cooling a cooling jacket on which each light source is placed.

In addition, the cooling unit 130 cools the power unit 120 and an imager (a DMD 500 which will be described later), in addition to each light source.

The color separation and combination unit 140 separates white light W into red component light R, green component light G, and blue component light B. Moreover, the color separation and combination unit 140 re-combines the red component light R, the green component light G, and the blue component light B with one another and output image light to the projection unit 150. Details of the color separation and combination unit 140 will be given later (see FIG. 3).

The projection unit 150 is that projects the light (the image light) emitted from the color separation and combination unit 140 onto the projection surface 300. Specifically, the projection unit 150 includes a projection lens group (a projection lens group 151 illustrated in FIG. 3) that projects the light emitted from the color separation and combination unit 140 onto the projection surface 300, and the reflection mirror (the concave mirror 152 illustrated in FIG. 3) that reflects light emitted from the projection lens group toward the projection surface 300. Details of the projection unit 150 will be given later.

The projection surface-side concave unit 160A and the projection surface-side concave unit 160B are provided in the projection surface-side sidewall 210, and are recessed inward the housing member 200. The projection surface-side concave unit 160A and the projection surface-side concave unit 160B extend up to an end of the housing member 200. The projection surface-side concave unit 160A and the projection surface-side concave unit 160B are provided with ventilation ports communicating with the inner side of the housing member 200.

In the first embodiment, the projection surface-side concave unit 160A and the projection surface-side concave unit 160B extend along the width direction of the housing member 200. For example, the projection surface-side concave unit 160A is provided with an inlet (the ventilation port) through which the air outside the housing member 200 flows into the housing member 200. The projection surface-side concave unit 160B is formed with an outlet (the ventilation port) through which the air inside the housing member 200 flows out of the housing member 200.

The front-side convex unit 170 is provided in the front-side sidewall 220 and protrudes outward the housing member 200. The front-side convex unit 170 is provided at approximately the center of the front-side sidewall 220 in the width direction of the housing member 200. In a space formed by the front-side convex unit 170 at the inner side of the housing member 200, the reflection mirror (the concave mirror 152 illustrated in FIG. 3) provided in the projection unit 150 is located.

The top plate concave unit 180 is provided in the top plate 240 and is recessed inward the housing member 200. The top plate concave unit 180 has an inclined plane 181 descending toward the projection surface 300. The inclined plane 181 has a transmission area where the light emitted from the projection unit 150 transmits (projects) toward the projection surface 300.

The cable terminal 190 is provided in the first side surface-side sidewall 250 and includes a power terminal, an image terminal and the like. In addition, the cable terminal 190 may also be provided in the second side surface-side sidewall 260.

### (Configuration of Light Source Unit, Color Separation and Combination Unit, and Projection Unit)

Hereinafter, the configuration of the light source unit, the color separation and combination unit, and the projection unit according to the first embodiment will be described with reference to the accompanying drawings. FIG. 3 is a diagram illustrating the light source unit 110, the color separation and combination unit 140, and the projection unit 150 according to the first embodiment. In the first embodiment, the projection display apparatus 100 corresponding to a DLP (Digital Light Processing) scheme (a registered trademark) will be described as an example.

As illustrated in FIG. 3, the light source unit 110 includes a plurality of solid light sources 111W, a plurality of optical fibers 113W, and a bundle unit 114W. As described above, the solid light source 111W is a semiconductor laser element such as an LD that emits white light W having coherency. The optical fibers 113W are connected to the solid light sources 111W, respectively.

The optical fibers 113W connected to the solid light sources 111W are bundled by the bundle unit 114W. That is, light emitted from each solid light source 111W is transferred through each optical fiber 113W and is collected by the bundle unit 114W. The solid light sources 111W are placed on a cooling jacket (not illustrated) for cooling the solid light sources 111W.

The color separation and combination unit 140 includes a rod integrator 10W, a lens 21W, a lens 23, a mirror 34, and a mirror 35. Furthermore, the color separation and combination unit 140 includes an optical diffuser 600.

The rod integrator 10W has a light incidence surface, a light exit surface, and a light reflection side surface provided from the outer periphery of the light incidence surface to the outer periphery of the light exit surface. The rod integrator 10W is that uniformizes the white light W emitted from the optical fiber 113W bundled by the bundle unit 114W. That is, the rod integrator 10W is that uniformizes the white light W by reflecting the white light W at the light reflection side surface.

In addition, the rod integrator 10W may also be a hollow rod in which a light reflection side surface is formed of a mirror surface. Furthermore, the rod integrator 10W may also be a solid rod formed of glass and the like.

The lens 21W approximately parallelizes the white light W so that each DMD 500 is illuminated with the white light W. The lens 23 approximately focuses the white light W onto each DMD 500 while suppressing the spread of the white light W. The mirror 34 and the mirror 35 reflect the white light W.

The color separation and combination unit 140 includes a lens 40, a prism 50, a prism 60, a prism 70, a prism 80, a prism 90, a plurality of DMDs (Digital Micromirror Devices; the DMD 500R, the DMD 500G, and the DMD 500B).

The lens 40 approximately parallelizes the white light W so that each DMD 500 is illuminated with each color component light.

The prism 50 is formed of a light transmitting member and has a plane 51 and a plane 52. Since an air gap is provided between the prism 50 (the plane 51) and the prism 60 (a plane 61) and an angle (an incident angle) at which the white light W is incident upon the plane 51 is larger than the total reflection angle, the white light W is reflected at the plane 51. Meanwhile, since an air gap is provided between the prism 50 (the plane 52) and the prism 70 (a plane 71) but an angle (an incident angle) at which the white light W is incident upon the plane 52 is smaller than the total reflection angle, the white light W reflected at the plane 51 transmits the plane 52.

The prism 60 is formed of a light transmitting member and has a plane 61.

The prism 70 is formed of a light transmitting member and has a plane 71 and a plane 72. Since an air gap is provided between the prism 50 (the plane 52) and the prism 70 (the plane 71) and an angle (an incident angle) at which blue component light B reflected at the plane 72 and blue component light B emitted from the DMD 500B are incident upon the plane 71 is larger than the total reflection angle, the blue component light B reflected at the plane 72 and the blue component light B emitted from the DMD 500B are reflected at the plane 71.

The plane 72 is a dichroic mirror surface that transmits red component light R and green component light G and reflects blue component light B. Thus, among the light beams reflected at the plane 51, the red component light R and the green component light G pass through the plane 72, and the blue component light B is reflected at the plane 72. The blue component light B reflected at the plane 71 is reflected at the plane 72.

The prism 80 is formed of a light transmitting member and has a plane 81 and a plane 82. Since an air gap is provided between the prism 70 (the plane 72) and the prism 80 (the plane 81) and an angle (an incident angle) at which red component light R reflected at the plane 82 by transmitting the plane 81 and red component light R emitted from the DMD 500R are again incident upon the plane 81 is larger than the total reflection angle, the red component light R reflected at the plane 82 by transmitting the plane 81 and the red component light R emitted from the DMD 500R are reflected at the plane 81. Meanwhile, since an angle (an incident angle) at which the red component light R reflected at the plane 82 after emerging from the DMD 500R and reflected at the plane 81 is again incident upon the plane 81 is smaller than the total reflection angle, the red component light R reflected at the plane 82 after emerging from the DMD 500R and reflected at the plane 81 transmits the plane 81.

The plane 82 is a dichroic mirror surface that transmits the green component light G and reflects the red component light R. Thus, among the light beams having transmitted the plane 81, the green component light G passes through the plane 82 and the red component light R is reflected at the plane 82. The red component light R reflected at the plane 81 is reflected at the plane 82. A green component light G emitted from the DMD 500G transmits the plane 82.

Here, the prism 70 separates the combined light including the red component light R and the green component light G from the blue component light B using the plane 72. The prism 80 separates the red component light R from the green component light G using the plane 82. That is, the prism 70 and the prism 80 function as color separating elements that separates each color component light.

In addition, in the first embodiment, a cut-off wavelength of the plane 72 of the prism 70 exists between a waveband corresponding to a green color and a waveband corresponding to a blue color. A cut-off wavelength of the plane 82 of the prism 80 is provided between a waveband corresponding to the red color and a waveband corresponding to the green color.

Meanwhile, the prism 70 combines the combined light including the red component light R and the green component light G with the blue component light B using the plane 72. The prism 80 combines the red component light R with the green component light G using the plane 82. That is, the prism 70 and the prism 80 function as color combining elements that combines each color component light.

The prism 90 is formed of a light transmitting member and has a plane 91. The plane 91 transmits the green component light G. In addition, the green component light G incident upon the DMD 500G and the green component light G emitted from the DMD 500G pass through the plane 91.

The DMD 500R, the DMD 500G, and the DMD 500B are formed of a plurality of micromirrors, respectively, and the plurality of micromirrors are a movable type. Each micromirror basically corresponds to one pixel. The DMD 500R changes an angle of each micromirror to switch whether to reflect the red component light R toward the projection unit 150. In the same manner, the DMD 500G and the DMD 500B change the angle of each micromirror to switch whether to reflect green component light G and the blue component light B toward the projection unit 150.

The projection unit 150 includes the projection lens group 151 and the concave mirror 152.

The projection lens group 151 is that emits the light (the image light), emitted from the color separation and combination unit 140, toward the concave mirror 152.

The concave mirror 152 reflects the light (the image light) reflected from the projection lens group 151. The concave mirror 152 collects the image light and then widens an angle of the image light. For example, the concave mirror 152 is an aspherical mirror having a concave surface at the projection lens group 151-side.

The image light collected by the concave mirror 152 transmits the transmission area provided in the inclined plane 181 of the top plate concave unit 180 provided in the top plate 240. Preferably, the transmission area provided in the inclined plane 181 is provided around a position at which the image light is collected by the concave mirror 152.

As described above, the concave mirror 152 is located in a space formed by the front-side convex unit 170. For example, preferably, the concave mirror 152 is fixed at the inner side of the front-side convex unit 170. Furthermore, preferably, the inner side surface of the front-side convex unit 170 has a shape along the concave mirror 152.

Here, in the first embodiment, the color separation and combination unit 140 includes the optical diffuser 600 (a speckle noise reduction element) as described above. The optical diffuser 600 is a unit which is provided between the light source unit 110 and the DMD 500 on an optical path of the light emitted from the light source unit 110 and reduces speckle noise of the light emitted from the light source unit 110. In other words, the optical diffuser 600 is an optical element that reduces spatial coherence of the white light W in order to reduce a speckle. Specifically, the optical diffuser 600 diffuses the white light W uniformized by the rod integrator 10W and transmits the white light W. For example, the optical diffuser 600 may have the following configuration.

### First Configuration Example

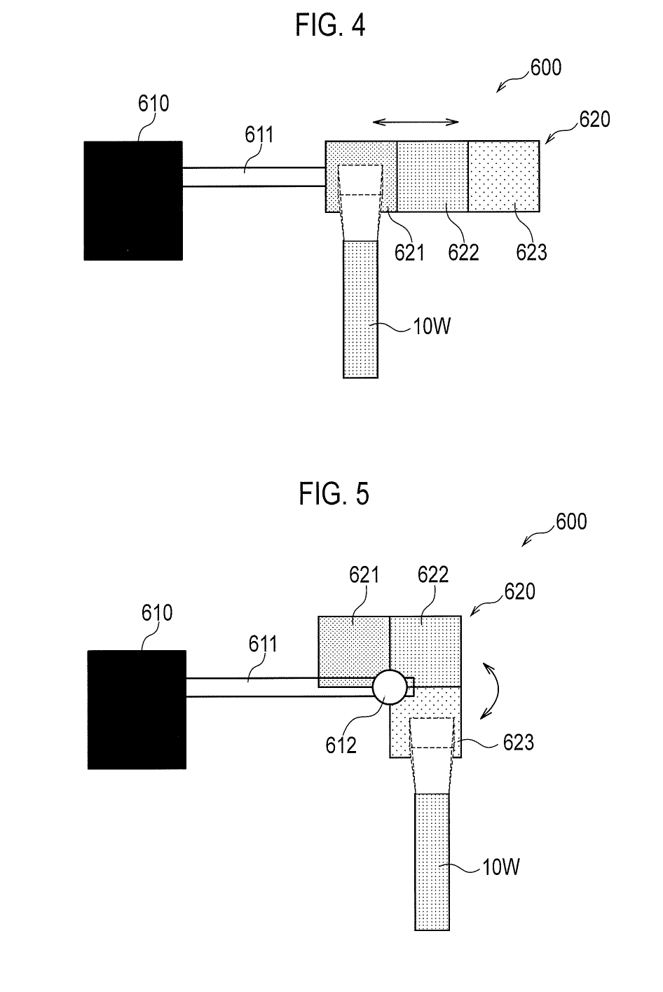

In the first configuration example, as illustrated in FIG. 4, the optical diffuser 600 includes a driving device 610 and a diffusion plate 620.

The driving device 610 is connected to the diffusion plate 620 through an arm 611 to control the diffusion plate 620 by the driving of the arm 611.

The diffusion plate 620 is arranged between the light source unit 110 and the DMD 500 on the optical path of the light emitted from the light source unit 110. The diffusion plate 620 diffuses the light emitted from the light source unit 110 and transmits the light emitted from the light source unit 110.

Specifically, the diffusion plate 620 has a plurality of areas (a diffusion area 621, a diffusion area 622, and a diffusion area 6213) with different degrees of diffusion. In the first embodiment, the diffusion degree of the diffusion area 621 is higher than the diffusion degree of the diffusion area 622, and the diffusion degree of the diffusion area 622 is higher than the diffusion degree of the diffusion area 623.

Here, in the first configuration example, the driving device 610 switches an area, where the light emitted from the rod integrator 10W is illuminated, among the diffusion areas 621 to 623 by the driving of the arm 611. Furthermore, the driving device 610 vibrates the irradiation area of the light emitted from the rod integrator 10W by the driving of the arm 611.

### Second Configuration Example

In the second configuration example, as illustrated in FIG. 5, the optical diffuser 600 includes the driving device 610 and the diffusion plate 620 similarly to the first configuration example.

Here, in the second configuration example, the driving device 610 is connected to a rotating member 612 to drive the rotating member 612. The driving device 610 switches the irradiation area of the light emitted from the rod integrator 10W among the diffusion areas 621 to 623 by the driving of the rotating member 612. Furthermore, similarly to the first configuration example, the driving device 610 vibrates the irradiation area of the light emitted from the rod integrator 10W by the driving of the arm 611.

### Third Configuration Example

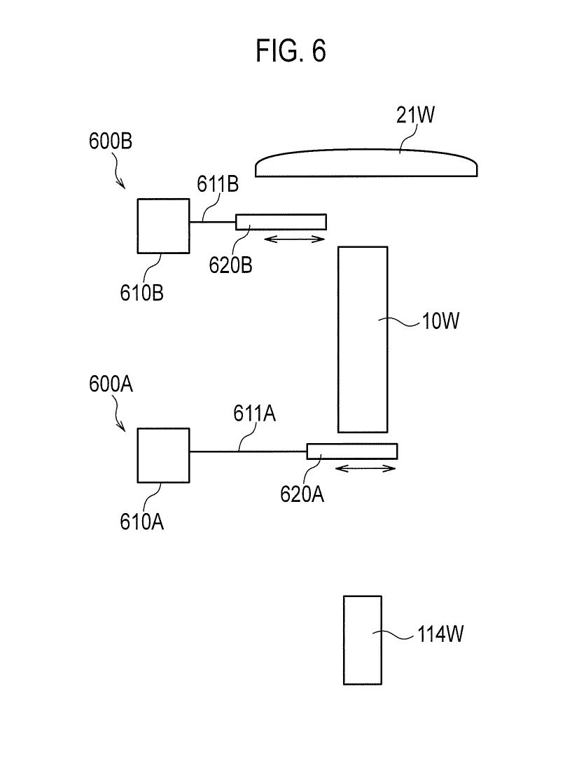

In the third configuration example, as illustrated in FIG. 6, a speckle reduction unit 600A is provided at a light incidence side of the rod integrator 10W, and a speckle reduction unit 600B is provided at a light exit side of the rod integrator 10W. The speckle reduction unit 600A and the speckle reduction unit 600B have the same configuration as that of the optical diffuser 600.

Furthermore, a diffusion plate 620A provided in the speckle reduction unit 600A is arranged on an optical path of a light incident upon the rod integrator 10W. A diffusion plate 620B provided in the speckle reduction unit 600B is arranged on an optical path of light emitted from the rod integrator 10W.

In addition, in the third configuration example, the diffusion plate 620A and the diffusion plate 620B may include only an area with a single diffusion degree. However, the diffusion degree of the diffusion plate 620A may be different from the diffusion degree of the diffusion plate 620B.

For example, in the third configuration example, a driving device 610B provided in the speckle reduction unit 600B may drive an arm 611B so that the diffusion plate 620B is arranged on the optical path of the light emitted from the rod integrator 10W. Furthermore, the driving device 610B may drive the arm 611B so that the diffusion plate 620B is arranged out of the optical path of the light emitted from the rod integrator 10W.

In addition, a driving device 610A provided in the speckle reduction unit 600A may drive an arm 611A so that the diffusion plate 620A is arranged on the optical path of the light emitted from the rod integrator 10W. Furthermore, the driving device 610A may drive the arm 611A so that the diffusion plate 620A is arranged out of the optical path of the light emitted from the rod integrator 10W.

### (Configuration of Control Unit)

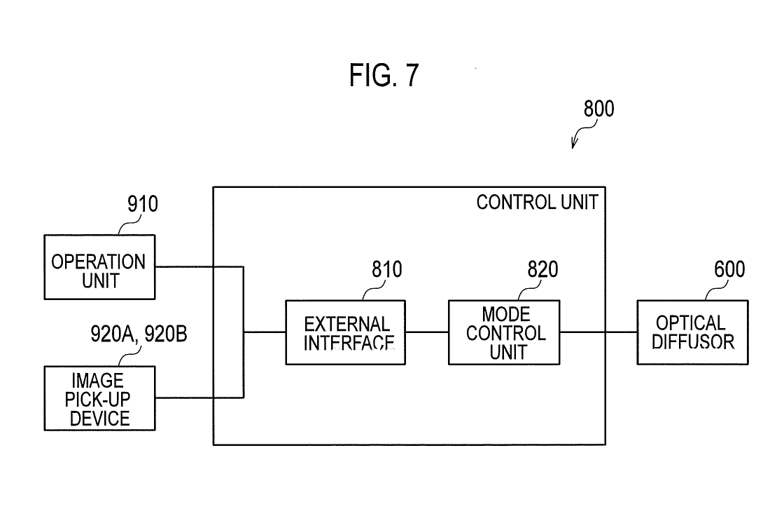

Hereinafter, the control unit according to the first embodiment is explained with reference to drawings. FIG. 7 is a block diagram illustrating a control unit 800 according to the first embodiment. The control unit 800 is arranged in the projection display apparatus 100 and controls the projection display apparatus 100.

The control unit 800 converts the image input signal into an image output signal. The image input signal is configured by a red input signal Rᵢₙ, a green input signal Gᵢₙ, and a blue input signal Bᵢₙ. The image output signal is configured by a red output signal Rₒᵤₜ, a green output signal Gₒᵤₜ, and a blue output signal Bₒᵤₜ. The image input signal and the image output signal are signals to be input in a respective one of a plurality of pixels configuring one frame.

Furthermore, in the first embodiment, the control unit 800 is that controls a plurality of modes (at least the first mode and the second mode) in which the degrees of diffusion of the light emitted from the light source unit 110 are different from each other. Here, as the diffusion degree is high, an effect of removing speckle noise is high. Meanwhile, as the diffusion degree is high, the luminance of an image displayed on the projection surface 300 is reduced because an effective light introduced to the DMD 500 is reduced. That is, the effect of removing the speckle noise and the luminance of the image displayed on the projection surface 300 have a trade-off relation.

In the first embodiment, the control unit 800 is that controls the plurality of modes in which the degrees of diffusion of the light emitted from the light source unit 110 are different from each other, thereby controlling whether to give priority to the speckle noise removal or the image luminance.

As illustrated in FIG. 7, the control unit 800 includes an external interface 810 and a mode control unit 820.

The external interface 810 is connected to an operation unit 910 and acquires an operation signal from the operation unit 910. In addition, the operation unit 910 may also be provided in the projection display apparatus 100 (the housing member 200) or a memory controller.

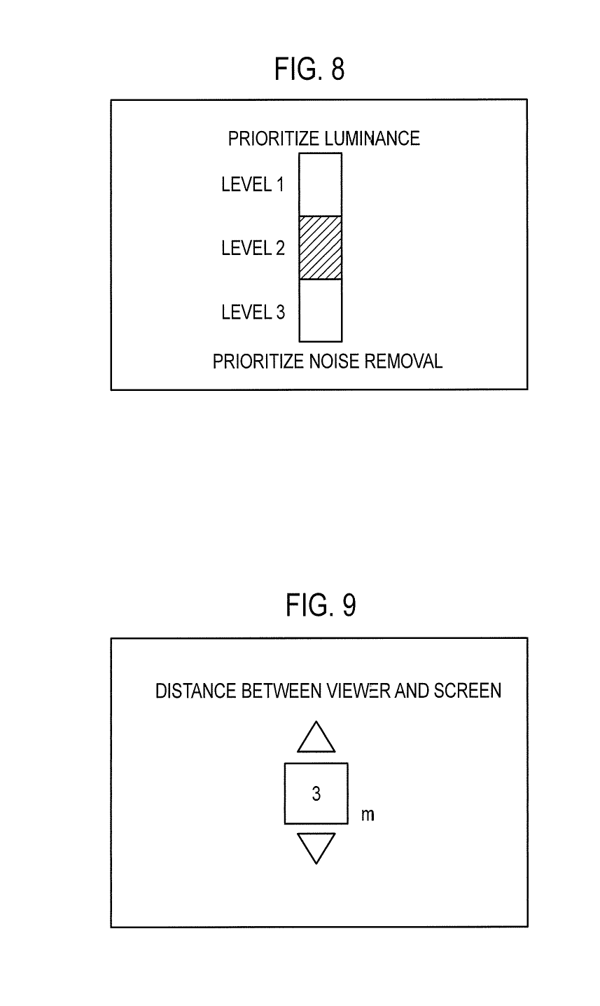

For example, as illustrated in FIG. 8, the operation signal may indicate a level by which the image luminance is prioritized. FIG. 8 illustrates three levels as an example. When level 1 is selected, the highest priority is given to the image luminance. That is, when the level 1 is selected, a mode is selected so that the diffusion degree of the light emitted from the light source unit 110 is minimized. Meanwhile, when level 3 is selected, the highest priority is given to the speckle noise removal. That is, when the level 3 is selected, a mode is selected so that the diffusion degree of the light emitted from the light source unit 110 is maximized.

Otherwise, for example, as illustrated in FIG. 9, the operation signal may indicate a distance between the projection surface 300 (a screen) and a viewer. Here, as the distance between the projection surface 300 (the screen) and the viewer is long, speckle noise is difficult to be observed. Thus, as the distance between the projection surface 300 (the screen) and the viewer is long, a mode is selected, in which the diffusion degree of the light emitted from the light source unit 110 is low.

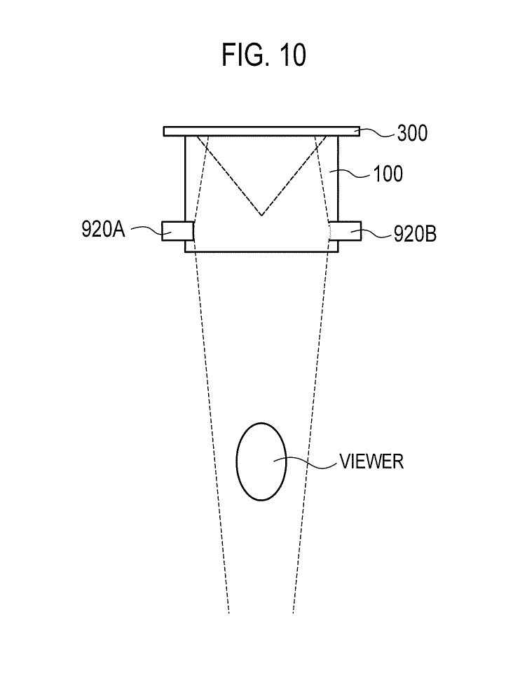

The external interface 810 is connected to an image pick-up device 920A and an image pick-up device 920B, and acquires a picked-up image from the image pick-up device 920A and the image pick-up device 920B. Here, as illustrated in FIG. 10, the image pick-up device 920A and the image pick-up device 920B are provided in the projection display apparatus 100 (the housing member 200) to capture an opposite side of the projection surface 300 with respect to the projection display apparatus 100. That is, the image pick-up device 920A and the image pick-up device 920B capture the viewer.

In addition, the distance between the projection surface 300 (the screen) and the viewer may be specified by the picked-up image acquired from the image pick-up device 920A and the image pick-up device 920B.

The mode control unit 820 is that controls the plurality of modes in which the degrees of diffusion of the light beams that emerge from the light source unit 110 are different from each other. Specifically, firstly, the mode control unit 820 selects a mode from the plurality of modes based on information acquired by the external interface 810.

For example, when the operation signal indicating the level by which the image luminance is prioritized is acquired by the external interface 810, the mode control unit 820 selects any one mode from the plurality of modes based on the level by which the luminance is prioritized. Otherwise, when the operation signal indicating the distance between the projection surface 300 (the screen) and the viewer is acquired by the external interface 810, the mode control unit 820 selects any one mode from the plurality of modes based on the distance between the projection surface 300 (the screen) and the viewer. Otherwise, when the picked-up image is acquired by the external interface 810, the mode control unit 820 specifies the distance between the projection surface 300 (the screen) and the viewer, and selects any one mode from the plurality of modes based on the distance between the projection surface 300 (the screen) and the viewer.

Secondly, the mode control unit 820 is that controls the driving device 610 provided in the optical diffuser 600 based on the selected mode.

For example, when the plurality of modes are three and the optical diffuser 600 corresponds to the first configuration example illustrated in FIG. 4, the mode control unit 820 controls the driving device 610 (the arm 611) based on the selected mode so that the irradiation area of the light emitted from the rod integrator 10W is switched among the diffusion areas 621 to 623. For example, in the case of selecting a mode in which the highest priority is given to the speckle noise removal, the mode control unit 820 controls the driving device 610 (the arm 611) so that the diffusion area 621 is illuminated with the light emitted from the rod integrator 10W. Meanwhile, in the case of selecting a mode in which the highest priority is given to the image luminance, the mode control unit 820 controls the driving device 610 (the arm 611) so that the diffusion area 623 is illuminated with the light emitted from the rod integrator 10W.

In the same manner, when the plurality of modes are three and the optical diffuser 600 corresponds to the second configuration example illustrated in FIG. 5, the mode control unit 820 controls the driving device 610 (the rotating member 612) based on the selected mode so that the irradiation area of the light emitted from the rod integrator 10W is switched among the diffusion areas 621 to 623.

Otherwise, when the plurality of modes are two and the optical diffuser 600 corresponds to the third configuration example illustrated in FIG. 6, the mode control unit 820 controls the number of optical diffusers through which the light emitted from the rod integrator 10W passes. Specifically, in the case of selecting a mode in which the priority is given to the speckle noise removal, the mode control unit 820 controls the driving device 610 (the arm 611B) so that the diffusion plate 620B is arranged out of the light emitted from the rod integrator 10W. Meanwhile, in the case of selecting a mode in which the priority is given to the image luminance, the mode control unit 820 controls the driving device 610 (the arm 611B) so that the diffusion plate 620B is arranged on the optical path of the light emitted from the rod integrator 10W.

Thirdly, the mode control unit 820 controls the driving device 610 (the arm 611) so that a diffusion plate (a diffusion area) arranged on the optical path of the light emitted from the rod integrator 10W operates in a predetermined operation pattern.

### (Operation and Effect)

In the first embodiment, the control unit 800 controls the optical diffuser 600 to diffuse the light emitted from the light source 110 in the first mode (for example, the mode in which the priority is given to the speckle noise removal), with the diffusion degree higher the diffusion degree in the second mode (for example, the mode in which the priority is given to the image luminance). That is, since the diffusion degree is high in the first mode as compared with in the second mode, speckle noise is effectively removed. Meanwhile, since the diffusion degree is low in the second mode as compared with in the first mode, luminance reduction is suppressed. That is, it is possible to appropriately achieve the speckle noise removal and the luminance reduction suppression through mode switching.

### First Modification

Hereinafter, the first modification of the first embodiment is explained with reference to drawings. The description below is based primarily on the differences from the firs: embodiment.

Specifically, in the first modification, the optical diffuser 600 has a different configuration as compared with the first embodiment.

### (Configuration of Optical Diffuser)

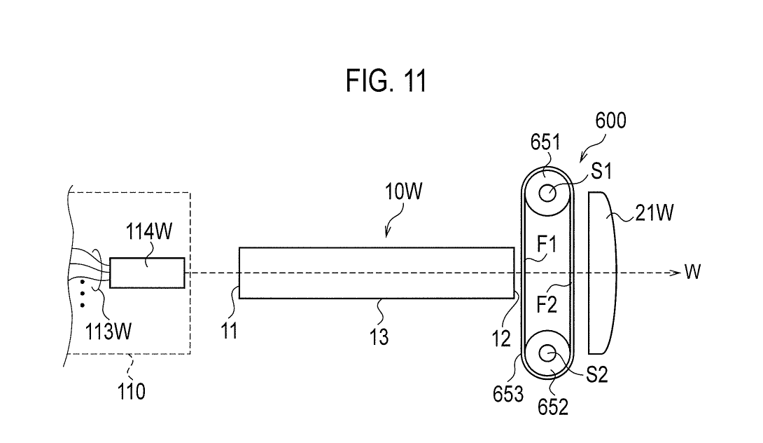

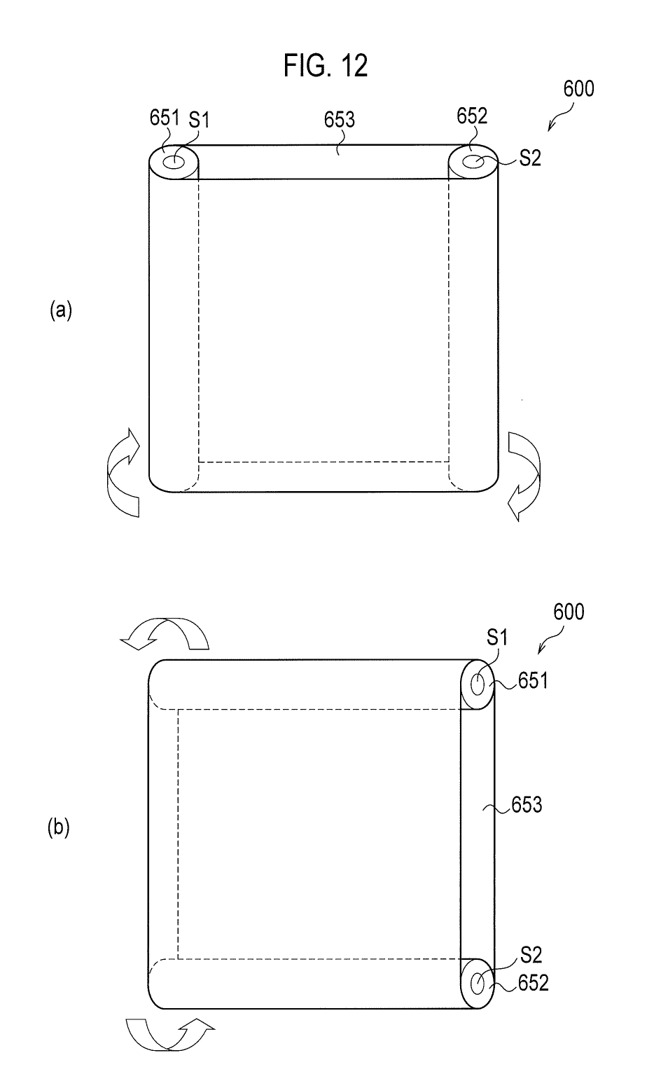

Hereinafter, the configuration of the optical diffuser according to the first modification will be described with reference to the accompanying drawings. FIG. 11 and FIG. 12 are diagrams illustrating the optical diffuser 600 according to the first modification.

As illustrated in FIG. 11 and FIG. 12, the optical diffuser 600 includes a pair of rotating members (a rotating member 651 and a rotating member 652), and a belt-like diffusion sheet 653 wound around the rotating member 651 and the rotating member 652 in an endless loop.

The rotating member 651 is rotatable about a rotating axis S1. The rotating member 652 is rotatable about a rotating axis S2 which is approximately parallel to the rotating axis S1. A driving device (not illustrated) is connected to any one of the rotating axis S1 and the rotating axis S2. For example, the driving device includes a motor that rotates the rotating axis S1. Here, if the rotating member 651 rotates, rotating force of the rotating member 651 is transferred to the rotating member 652 through the belt-like diffusion sheet 653. Thus, the rotating member 652 also rotates. That is, rather than using two motors, one motor is driven to enable the rotation of both the rotating member 651 and the rotating member 652.

The rotating member 651 and the rotating member 652 are cylindrical and have approximately the same shape. Between the rotating member 651 and the rotating member 652, provided is an interval with approximately the same as the diameter of light flux emitted from the light exit surface of the rod integrator 10W.

The belt-like diffusion sheet 653 is formed of a light transmitting member. The belt-like diffusion sheet 653 has micro concave-convexes engraved thereon. The belt-like diffusion sheet 653 diffuses the white light W emitted from the rod integrator 10W and transmits the white light W. The belt-like diffusion sheet 653 has a width which is approximately the same as the diameter of the light flux emitted from the rod integrator 10W.

The belt-like diffusion sheet 653 constitutes a diffusion surface F1 and a diffusion surface F2 which are placed and separated in the travel direction of the white light W. Each of the diffusion surface F1 and the diffusion surface F2 has a size which is approximately the same as the diameter of the light flux. Each of the diffusion surface F1 and the diffusion surface F2 continuously moves according to the rotation of the rotating member 651 and the rotating member 652. The movement direction of the diffusion surface F1 is opposite to the movement direction of the diffusion surface F2.

In the first modification, the diffusion surface F1 is a first diffusion surface which continuously moves in a predetermined direction. The diffusion surface F2 is a second diffusion surface which continuously moves in a direction opposite to the predetermined direction (the movement direction of the diffusion surface F1).

Firstly, the white light W emitted from the rod integrator 10W transmits the diffusion surface F1 and then transmits the diffusion surface F2. When the white light W transmits the diffusion surface F1, the white light W is diffused by the diffusion surface F1. When the white light W transmits the diffusion surface F2, the white light W is diffused by the diffusion surface F2.

In addition, it is sufficient if the directions of the rotating axis S1 and the rotating axis S2 are approximately perpendicular to the optical axis of the rod integrator 10W. That is, it is sufficient if the diffusion surface F1 and the diffusion surface F2 are approximately perpendicular to the optical axis of the rod integrator 10W.

For example, as illustrated in FIG. 12 (a), the optical diffuser 600 may also be arranged so that the directions of the rotating axis S1 and the rotating axis S2 are the same as the height direction of the projection display apparatus 100. In the case illustrated in FIG. 12 (a), the diffusion surface F1 and the diffusion surface F2 move along the height direction of the projection display apparatus 100.

Otherwise, as illustrated in FIG. 12 (b), the optical diffuser 600 may also be arranged so that the directions of the rotating axis S1 and the rotating axis S2 are the same as the width direction of the projection display apparatus 100. In the case illustrated in FIG. 12 (b), the diffusion surface F1 and the diffusion surface F2 move along the width direction of the projection display apparatus 100.

### (Operation and Effect)

In the first modification, the white light W is diffused by the diffusion surface F1 and the diffusion surface F2, and the diffusion surface F1 and the diffusion surface F2 continuously move. In other words, the diffusion surface F1 and the diffusion surface F2 always move without being stopped. Consequently, it is possible to always maintain a speckle noise reduction effect.

In the first modification, the belt-like diffusion sheet 653 wound around the rotating member 651 and the rotating member 652 in the endless loop constitutes the diffusion surface F1 and the diffusion surface F2. Thus, the size of the optical diffuser 600 can be made to be approximately the same as the size of the light flux emitted from the rod integrator 10W. Consequently, it is possible to miniaturize the optical diffuser 600, resulting in the miniaturization of the projection display apparatus 100.

In the first modification, the rotating member 651 and the rotating member 652 are rotated by one motor, so that it is possible to reduce power consumption.

In the first modification, the optical diffuser 600 is provided at the light exit side of the rod integrator 10W. Consequently, as compared with the case in which the optical diffuser 600 is provided at the light incidence side of the rod integrator 10W, it is possible to prevent light use efficiency from being reduced. Specifically, in the case in which the optical diffuser 600 is provided at the light incident-side of the rod integrator 10W, a part of the light flux diffused by the optical diffuser 600 may not be incident upon the rod integrator 10W.

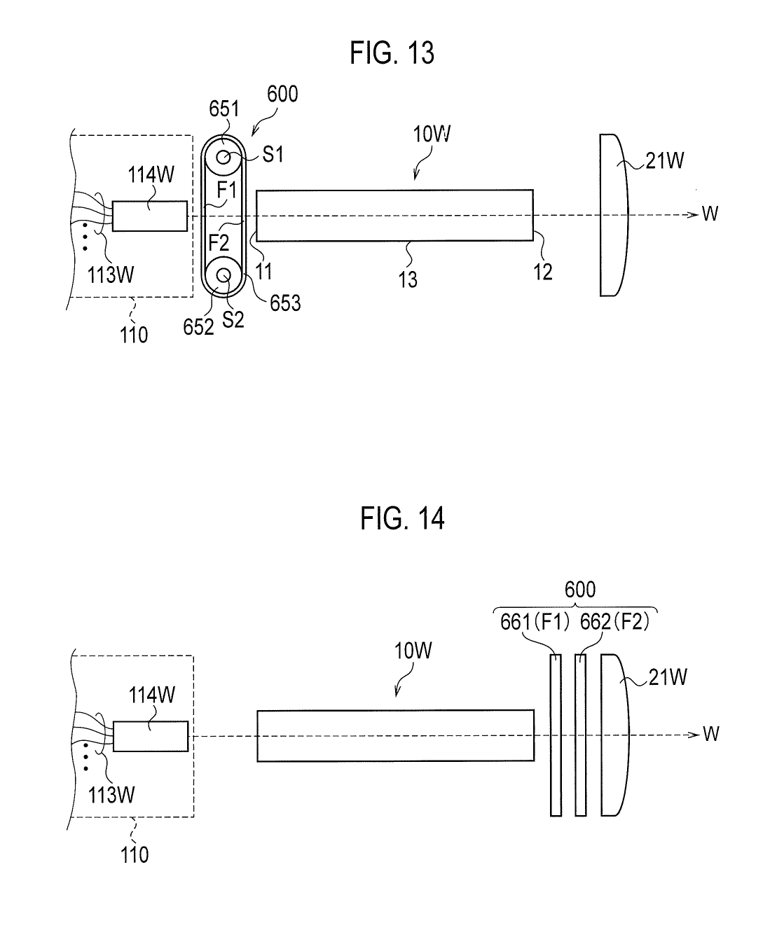

However, as illustrated in FIG. 13, the optical diffuser 600 may also be provided at the light incidence sidle of the rod integrator 10W. In such a case, it is preferable that the sizes of the diffusion surface F1 and the diffusion surface F2 are smaller than the light incidence surface of the rod integrator 10W by the belt-like diffusion sheet 653 wound around the rotating member 651 and the rotating member 652 in the endless loop.

Consequently, in the case illustrated in FIG. 13, as compared with the case in which the optical diffuser 600 is provided at the light exit side of the rod integrator 10W, it is possible to miniaturize the optical diffuser 600.

### Second Modification

Hereinafter, a second modification of the first embodiment is explained with reference to drawings. The description below is based primarily on the differences from the first embodiment.

Specifically, in the second modification, an optical diffuser 600 has a different configuration as compared with the first embodiment.

### (Configuration of Optical Diffuser)

Hereinafter, the configuration of the optical diffuser according to the first modification will be described with reference to the accompanying drawings. FIG. 14 is a diagram illustrating the optical diffuser 600 according to the second modification.

As illustrated in FIG. 14, the optical diffuser 600 includes a plurality of diffusion plates (a diffusion plate 661 and a diffusion plate 662). The diffusion plate 661 and the diffusion plate 662 are arranged at the light exit side of the rod integrator 10W.

In the first modification, the diffusion plate 661 is a first diffusion plate vibrating along a predetermined direction. The diffusion plate 662 vibrates in a direction different from a vibration direction of the diffusion plate 661. That is, the control unit 800 controls the optical diffuser 600 so that the diffusion plate 661 and the diffusion plate 662 vibrate along different directions.

The diffusion plate 661 and the diffusion plate 662 are formed of a light transmitting member and have micro concave-convexes engraved thereon. The diffusion plate 661 and the diffusion plate 662 diffuse the white light W emitted from the rod integrator 10W and transmit the white light W.

Here, when one of the diffusion plate 661 and the diffusion plate 662 stops, the control unit 800 controls the optical diffuser 600 so that the other one of the diffusion plate 661 and the diffusion plate 662 moves.

For example, when a vibration phase of the diffusion plate 661 (a diffusion surface F1) is set to φ and a vibration phase of the diffusion plate 662 (a diffusion surface F2) is set to φ′, the control unit 800 controls the optical diffuser 600 so that a relation of φ′≠Φnπ is satisfied.

In addition, it is sufficient if longitudinal and transverse sizes of the diffusion plate 661 and the diffusion plate 662 are approximately the same or larger as the light exit surface (a size of the light flux emitted from the light exit surface) of the rod integrator 10W. FIG. 14 illustrates the case in which the longitudinal and transverse sizes of the diffusion plate 661 and the diffusion plate 662 are approximately the same as a size of the lens 21W.

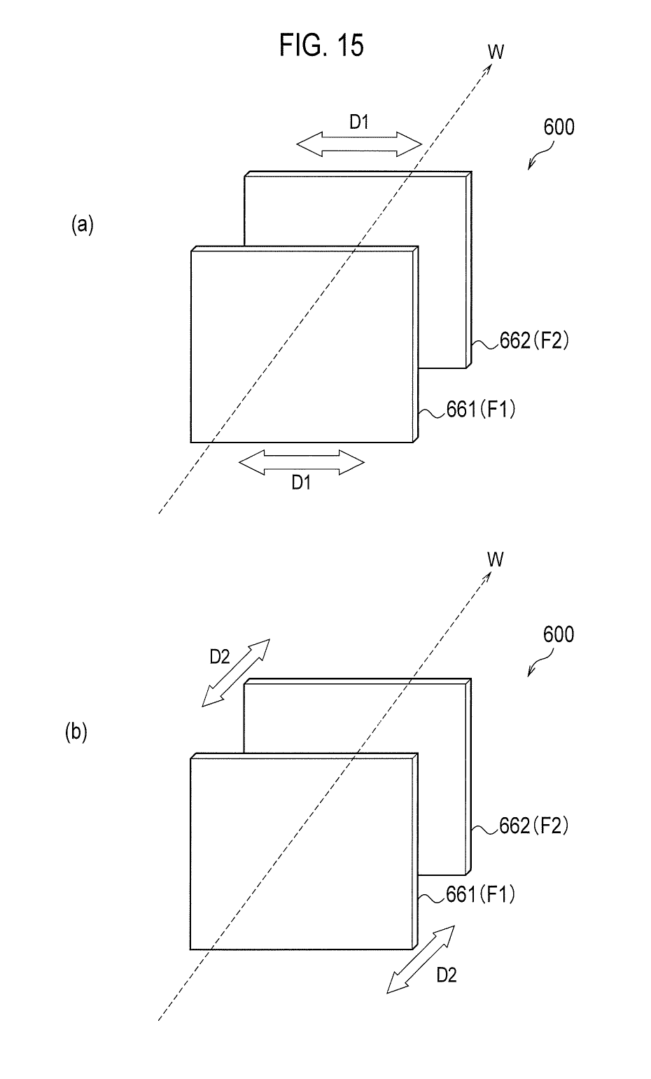

In addition, as illustrated in FIG. 15 (a) and FIG. 15 (b), vibration directions of the diffusion plate 661 and the diffusion plate 662 may also be equal to each other. For example, as illustrated in FIG. 15 (a), the vibration directions of the diffusion plate 661 and the diffusion plate 662 may also be a direction (a D1 direction) perpendicular to an optical axis w of the rod integrator 10W. Otherwise, as illustrated in FIG. 15 (b), the vibration directions of the diffusion plate 661 and the diffusion plate 662 may also be a direction (a D2 direction) which is the same as the optical axis w of the rod integrator 10W.

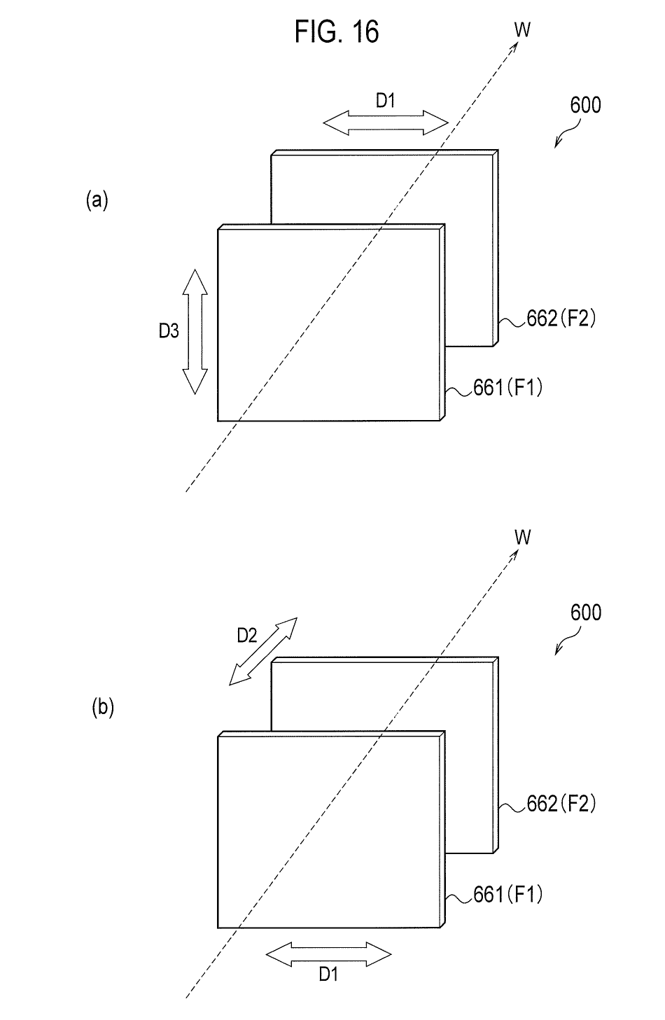

Furthermore, as illustrated in FIG. 16 (a) and FIG. 16 (b), the vibration directions of the diffusion plate 661 and the diffusion plate 662 may also be difficult from each other. For example, as illustrated in FIG. 16 (a), the vibration direction of the diffusion plate 661 may also be a D3 direction and the vibration direction of the diffusion plate 662 may also be a D1 direction. Otherwise, as illustrated in FIG. 16 (b), the vibration direction of the diffusion plate 661 may also be the D1 direction and the vibration direction of the diffusion plate 662 may also be a D2 direction.

### (Operation and Effect)

In the second modification, the white light W is diffused by the diffusion plate 661 (the diffusion surface F1) and the diffusion plate 662 (the diffusion surface F2), and at least one of the diffusion plate 661 (the diffusion surface F1) and the diffusion plate 662 (the diffusion surface F2) always moves. Consequently, it is possible to always maintain a speckle noise reduction effect.

### Third Modification

Hereinafter, the third modification of the first embodiment will be described with reference to the accompanying drawing. Hereinafter, the third modification will be described while focusing on the difference from the second modification. Specifically, in the third modification, the diffusion plate 661 and the diffusion plate 662 have different arrangements.

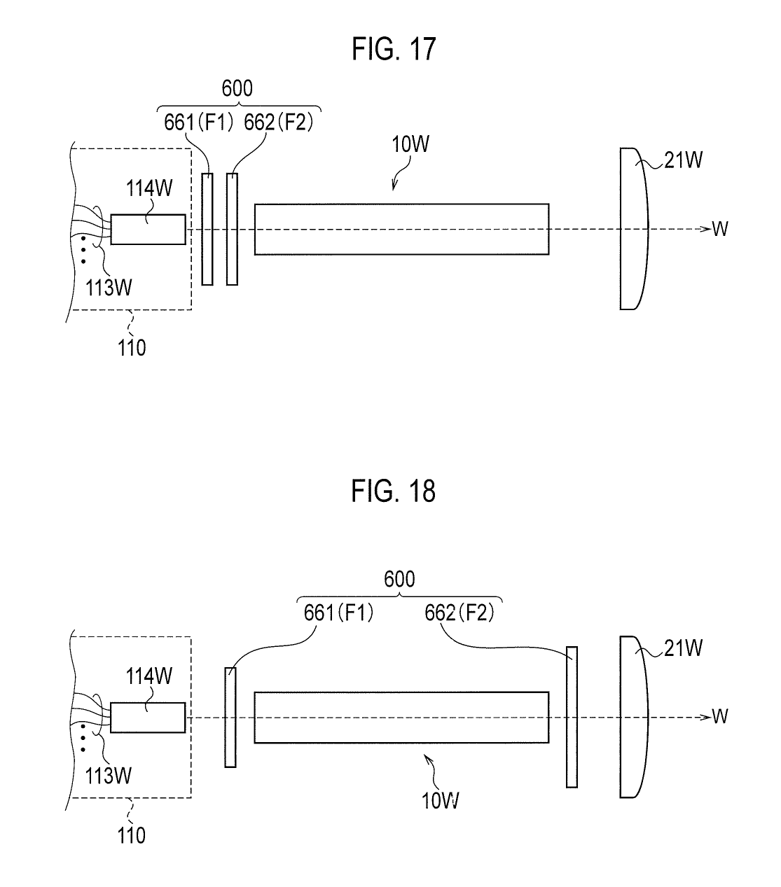

For example, as illustrated in FIG. 17, the diffusion plate 661 and the diffusion plate 662 may also be arranged at the light incidence side of the rod integrator 10W. Otherwise, as illustrated in FIG. 18, the diffusion plate 661 may also be arranged at the light incidence side of the rod integrator 10W, and the diffusion plate 662 may also be arranged at the light exit side of the rod integrator 10W.

### Overview of Second Embodiment

### Problem of Second Embodiment

The projection display apparatus includes a relay optical unit and a projection unit, and a diaphragm of the relay optical unit and a diaphragm (an exit pupil) of the projection unit have a conjugate relation.

Here, in the diaphragm surface of the relay optical unit and the diaphragm surface (the exit pupil surface) of the projection unit, spatial distribution of light intensity corresponds to Gaussian distribution reflecting angle distribution of light beams that emerge from a laser light source.

Thus, when considering light flux reaching one point (for example, a center point of a projection surface) of the projection surface from the diaphragm surface (the exit pupil surface) of the projection unit, the intensities of light beams reaching one point of the projection surface from a peripheral area of the diaphragm surface (the exit pupil surface) of the projection unit are smaller than the intensities of light beams reaching one point of the projection surface from a center area of the diaphragm surface (the exit pupil surface) of the projection unit.

As described above, since the intensities of the light beams reaching one point of the projection surface from the diaphragm surface (the exit pupil surface) of the projection unit do not show a uniform angle distribution, the speckle noise reduction effect due to angle superposition may not be sufficiently exhibited, so that speckle noise may be observed.

### Configuration of Second Embodiment

A projection display apparatus according to the second embodiment includes a light source that emits light having coherency, an imager that modulates light emitted from the light source, a projection unit that projects light emitted from the imager onto a projection surface, and a relay optical unit that relays the light emitted from the light source so that the imager is illuminated with the light emitted from the light source. The projection display apparatus includes an uniformization optical element that uniformizes spatial distribution of light intensity on an exit pupil surface of the projection unit.

In the second embodiment, the uniformization optical element is that uniformizes the spatial distribution of light intensity on the exit pupil surface of the projection unit. Consequently, the intensities of the light beams reaching one point of the projection surface from the diaphragm surface (the exit pupil surface) of the projection unit show a uniform angle distribution, so that the speckle noise reduction effect due to the angle superposition can be sufficiently exhibited, thereby effectively removing speckle noise.

### Second Embodiment

### Configuration of Projection Display Apparatus

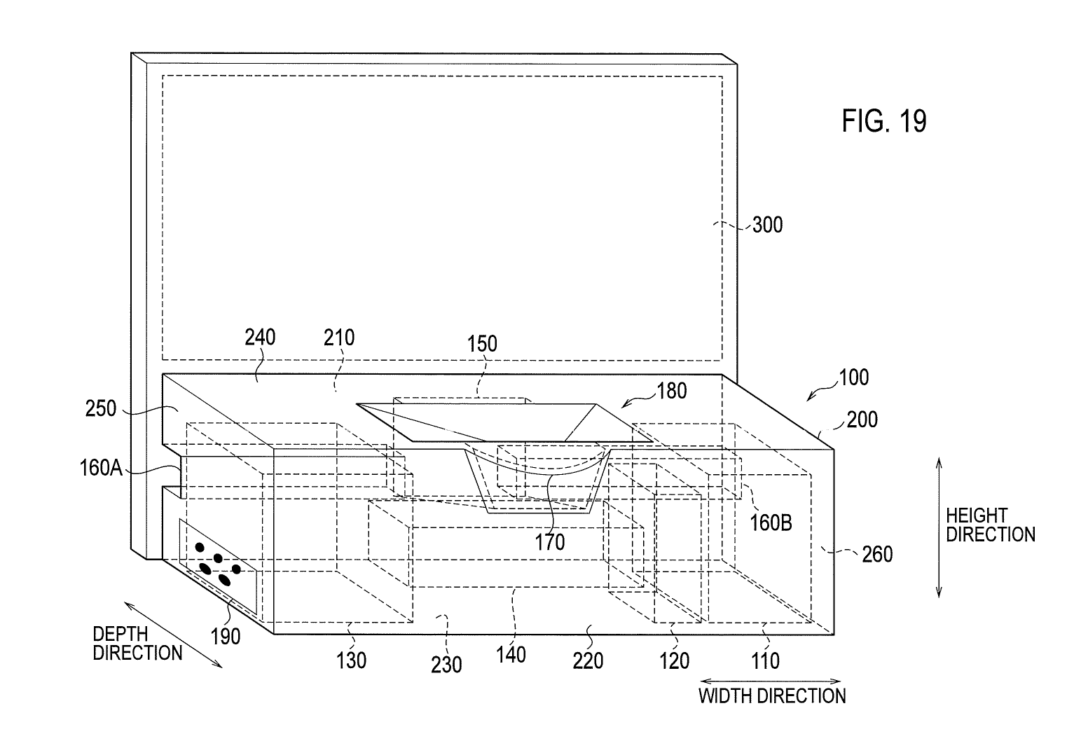

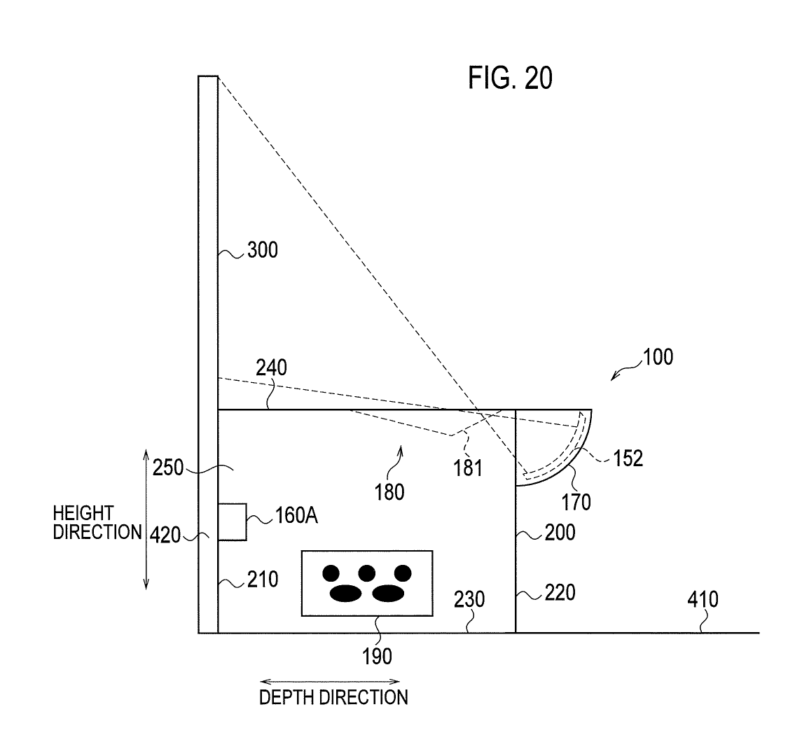

Hereinafter, the configuration of the projection display apparatus according to the second embodiment will be described with reference to the accompanying drawings. FIG. 19 is a perspective view illustrating a projection display apparatus 100 according to the second embodiment. FIG. 20 is a view in which the projection display apparatus 100 according to the second embodiment is seen from its side.

As illustrated in FIG. 19 and FIG. 20, the projection display apparatus 100 includes a housing member 200 and projects image onto a projection surface 300. Hereinafter, the case in which the projection display apparatus 100 projects image light onto the projection surface 300 provided to a wall surface will be described as an example (wall surface projection).

In such a case, the arrangement of the housing member 200 will be called wall surface projection arrangement. Specifically, the projection display apparatus 100 is arranged along a wall surface 420 and a floor surface 410 approximately perpendicular to the wall surface 420.

In the second embodiment, a horizontal direction parallel to the projection surface 300 will be called a “width direction”. A normal direction of the projection surface 300 will be called a “depth direction”. A direction perpendicular to both the width direction and the depth direction will be called a “height direction”.

The housing member 200 has an approximately rectangular parallelepiped shape. The size in the depth direction of the housing member 200 and the size in the height direction of the housing member 200 are smaller than the size in the width direction of the housing member 200. The size in the depth direction of the housing member 200 is approximately the same as a projection distance from a reflection mirror (a concave mirror 152 illustrated in FIG. 20) to the projection surface 300. In the width direction, the size of the housing member 200 is approximately the same as the size of the projection surface 300. In the height direction, the size of the housing member 200 is determined according to an installation position of the projection surface 300.

Specifically, the housing member 200 includes a projection surface-side sidewall 210, a front-side sidewall 220, a bottom plate 230, a top plate 240, a first side surface-side sidewall 250, and a second side surface-side sidewall 260.

The projection surface-side sidewall 210 is a plate-shaped member facing a first arrangement surface (the wall surface 420 in the second embodiment) which is approximately parallel to the projection surface 300. The front-side sidewall 22C is a plate-shaped member provided at an opposite side of the projection surface-side sidewall 210. The bottom plate 230 is a plate-shaped member facing the floor surface 410. The top plate 240 is a plate-shaped member provided at an opposite side of the bottom plate 230. The first side surface-side sidewall 250 and the second side surface-side sidewall 260 are plate-shaped members forming both ends of the housing member 200 in the width direction.

The housing member 200 houses a light source unit 110, a power unit 120, a cooling unit 130, a color separation and combination unit 140, and a projection unit 150. The projection surface-side sidewall 210 has a projection surface-side concave unit 160A and a projection surface-side concave unit 160B. The front-side sidewall 220 has a front-side convex unit 170. The top plate 240 has a top plate concave unit 180. The first side surface-side sidewall 250 has a cable terminal 190.

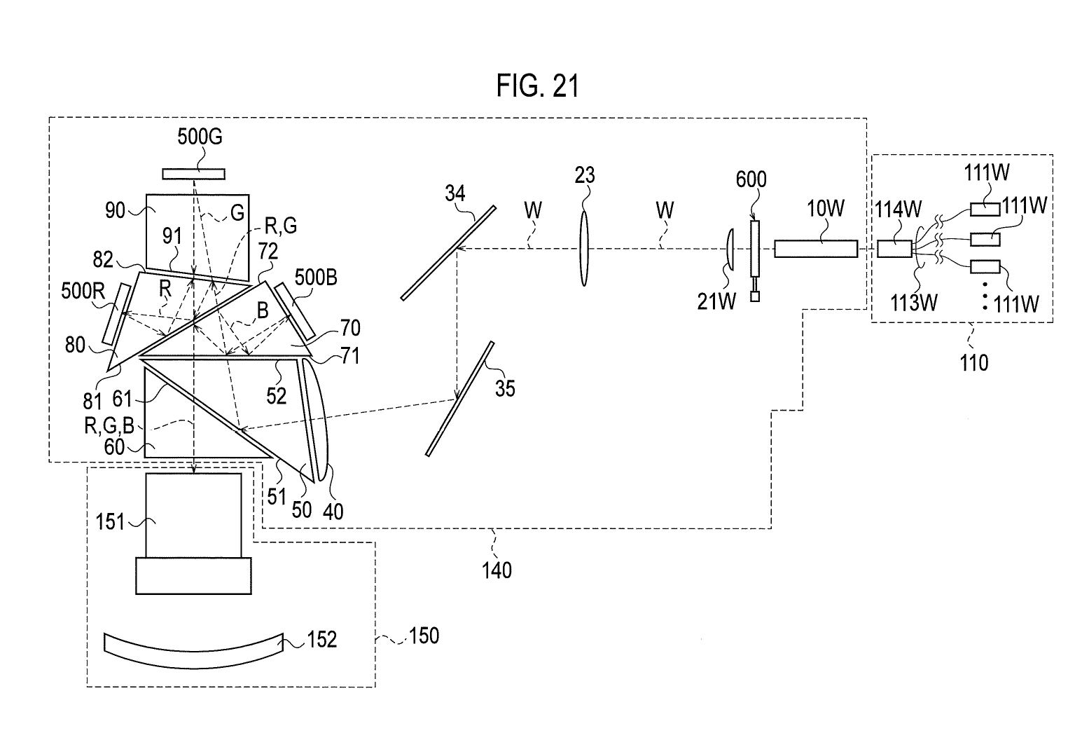

The light source unit 110 is formed of a plurality of light sources (solid light sources 111W illustrated in FIG. 21). Each light source is a semiconductor laser element such as an LD (laser diode). In the second embodiment, the plurality of solid light sources 111W output white light beams W having coherency. Details of the light source unit 110 will be given later.

The power unit 120 supplies power to the projection display apparatus 100. For example, the power unit 120 supplies power to the light source unit 110 and the cooling unit 130.

The cooling unit 130 cools the plurality of light sources provided in the light source unit 110. Specifically, the cooling unit 130 cools each light source by cooling a cooling jacket on which each light source is placed.

In addition, the cooling unit 130 cools the power unit 120 and an imager (a DMD 500 which will be described later), in addition to each light source.

The color separation and combination unit 140 separates white light W into red component light R, green component light G, and blue component light B. Moreover, the color separation and combination unit 140 re-combines the red component light R, the green component light G, and the blue component light B with one another and output image light to the projection unit 150. Details of the color separation and combination unit 140 will be given later (see FIG. 21).

The projection unit 150 is that projects the light (the image light) emitted from the color separation and combination unit 140 onto the projection surface 300. Specifically, she projection unit 150 includes a projection lens group (a projection lens group 151 illustrated in FIG. 21) that projects the light emitted from the color separation and combination unit 140 onto the projection surface 300, and the reflection mirror (the concave mirror 152 illustrated in FIG. 21) that reflects light emitted from the projection lens group toward the projection surface 300. Details of the projection unit 150 will be given later.

The projection surface-side concave unit 160A and the projection surface-side concave unit 160E are provided in the projection surface-side sidewall 210, and are recessed inward the housing member 200. The projection surface-side concave unit 160A and the projection surface-side concave unit 160B extend up to an end of the housing member 200. The projection surface-side concave unit 160A and the projection surface-side concave unit 160B are provided with ventilation ports communicating with the inner side of the housing member 200.

In the second embodiment, the projection surface-side concave unit 160A and the projection surface-side concave unit 160B extend along the width direction of the housing member 200. For example, the projection surface-side concave unit 160A is provided with an inlet (the ventilation port) through which the air outside the housing member 200 flows into the housing member 200. The projection surface-side concave unit 160B is provided with an outlet (the ventilation port) through which the air inside the housing member 200 flows out of the housing member 200.

The front-side convex unit 170 is provided in the front-side sidewall 220 and protrudes outward the housing member 200. The front-side convex unit 170 is provided at approximately the center of the front-side sidewall 220 in the width direction of the housing member 200. In a space formed by the front-side convex unit 170 at the inner side of the housing member 200, the reflection mirror (the concave mirror 152 illustrated in FIG. 21) provided in the projection unit 150 is located.

The top plate concave unit 180 is provided in the top plate 240 and is recessed inward the housing member 200. The top plate concave unit 180 has an inclined plane 151 descending toward the projection surface 300. The inclined plane 181 has a transmission area where the light emitted from the projection unit 150 transmits (projects) toward the projection surface 300.

The cable terminal 190 is provided in the first side surface-side sidewall 250 and includes a power terminal, an image terminal and the like. In addition, the cable terminal 190 may also be provided in the second side surface-side sidewall 260.

### (Configuration of Light Source Unit, Color Separation and Combination Unit, and Projection Unit)

Hereinafter, the configuration of the light source unit, the color separation and combination unit, and the projection unit according to the second embodiment will be described with reference to the accompanying drawings. FIG. 21 is a diagram illustrating the light source unit 110, the color separation and combination unit 140, and the projection unit 150 according to the second embodiment. In the second embodiment, the projection display apparatus 100 corresponding to a DLP (Digital Light Processing) scheme (a registered trademark) will be described as an example.

As illustrated in FIG. 21, the light source unit 110 includes a plurality of solid light sources 111W, a plurality of optical fibers 113W, and a bundle unit 114W. As described above, the solid light source 111W is a semiconductor laser element such as an LD that emits white light W having coherency. The optical fibers 113W are connected to the solid light sources 111W, respectively.

The optical fibers 113W connected to the solid light sources 111W are bundled by the bundle unit 114W. That is, light emitted from each solid light source 111W is transferred through each optical fiber 113W and is collected by the bundle unit 114W. The solid light sources 111W are placed on a cooling jacket (not illustrated) for cooling the solid light sources 111W.

The color separation and combination unit 140 includes a rod integrator 10W, a lens 21W, a lens 23, a mirror 34, and a mirror 35. Furthermore, the color separation and combination unit 140 includes an optical diffuser 600.

The rod integrator 10W has a light incidence surface, a light exit surface, and a light reflection side surface provided from the outer periphery of the light incidence surface to the outer periphery of the light exit surface. The rod integrator 10W is that uniformizes the white light W emitted from the optical fiber 113W bundled by the bundle unit 114W. That is, the rod integrator 10W is that uniformizes the white light W by reflecting the white light W at the light reflection side surface.

In addition, the rod integrator 10W may also be a hollow rod in which a light reflection side surface is formed of a mirror surface. Furthermore, the rod integrator 10W may also be a solid rod formed of glass and the like.

The lens 21W approximately parallelizes the white light W so that each DMD 500 is illuminated with the white light W. The lens 23 approximately focuses the white light W onto each DMD 500 while suppressing the spread of the white light W. The mirror 34 and the mirror 35 reflect the white light W.

The color separation and combination unit 140 includes a lens 40, a prism 50, a prism 60, a prism 70, a prism 80, a prism 90, a plurality of DMDs (Digital Micromirror Devices; the DMD 500R, the DMD 500G, and the DMD 500B).

The lens 40 approximately parallelizes the white light W so that each DMD 500 is illuminated with each color component light.

The prism 50 is formed of a light transmitting member and has a plane 51 and a plane 52. Since an air gap is provided between the prism 50 (the plane 51) and the prism 60 (a plane 61) and an angle (an incident angle) at which the white light W is incident upon the plane 51 is larger than the total reflection angle, the white light W is reflected at the plane 51. Meanwhile, since an air gap is provided between the prism 50 (the plane 52) and the prism 70 (a plane 71) but an angle (an incident angle) at which the white light W is incident upon the plane 52 is smaller than the total reflection angle, the white light W reflected at the plane 51 transmits the plane 52.

The prism 60 is formed of a light transmitting member and has a plane 61.

The prism 70 is formed of a light transmitting member and has a plane 71 and a plane 72. Since an air gap is provided between the prism 50 (the plane 52) and the prism 70 (the plane 71) and an angle (an incident angle) at which blue component light B reflected at the plane 72 and blue component light B emitted from the DMD 500B are incident upon the plane 71 is larger than the total reflection angle, the blue component light B reflected at the plane 72 and the blue component light B emitted from the DMD 500B are reflected at the plane 71.

The plane 72 is a dichroic mirror surface that transmits red component light R and green component light G and reflects blue component light B. Thus, among the light beams reflected at the plane 51, the red component light R and the green component light G transmits the plane 72, and the blue component light B is reflected at the plane 72. The blue component light B reflected at the plane 71 is reflected at the plane 72.

The prism 80 is formed of a light transmitting member and has a plane 81 and a plane 82. Since an air gap is provided between the prism 70 (the plane 72) and the prism 80 (the plane 81) and an angle (an incident angle) at which red component light R reflected at the plane 82 by transmitting the plane 81 and red component light R emitted from the DMD 500R are again incident upon the plane 81 is larger than the total reflection angle, the red component light R reflected at the plane 82 by transmitting the plane 81 and the red component light R emitted from the DMD 500R are reflected at the plane 81. Meanwhile, since an angle (an incident angle) at which the red component light R reflected at the plane 82 after emerging from the DMD 500R and reflected at the plane 81 is again incident upon the plane 81 is smaller than the total reflection angle, the red component light R reflected at the plane 82 after emerging from the DMD 500R and reflected at the plane 81 transmits the plane 81.

The plane 82 is a dichroic mirror surface that transmits the green component light G and reflects the red component light R. Thus, among the light beams having transmitted the plane 81, the green component light G transmits the plane 82 and the red component light R is reflected at the plane 82. The red component light R reflected at the plane 81 is reflected at the plane 82. A green component light G emitted from the DMD 500G transmits the plane 82.

Here, the prism 70 separates a combined light including the red component light R and the green component light G from the blue component light B using the plane 72. The prism 80 separates the red component light R from the green component light G using the plane 82. That is, the prism 70 and the prism 80 function as color separating elements that separates each color component light.

In addition, in the second embodiment, a cut-off wavelength of the plane 72 of the prism 70 exists between a waveband corresponding to a green color and a waveband corresponding to a blue color. A cut-off wavelength of the plane 82 of the prism 80 is provided between a waveband corresponding to the red color and a waveband corresponding to the green color.

Meanwhile, the prism 70 combines the combined light including the red component light R and the green component light G with the blue component light B using the plane 72. The prism 80 combines the red component light R with the green component light G using the plane 82. That is, the prism 70 and the prism 80 function as color combining elements that combines each color component light.

The prism 90 is formed of a light transmitting member and has a plane 91. The plane 91 is configure to transmit the green component light G. In addition, the green component light G incident upon the DMD 500G and the green component light G emitted from the DMD 500G pass through the plane 91.

The DMD 500R, the DMD 500G, and the DMD 500B are formed of a plurality of micromirrors, respectively, and each of micromirrors is movable. Each micromirror basically corresponds to one pixel. The DMD 500R changes an angle of each micromirror to switch whether to reflect the red component light R toward the projection unit 150. In the same manner, the DMD 500G and the DMD 500B change the angle of each micromirror to switch whether to reflect green component light G and the blue component light B toward the projection unit 150.

The projection unit 150 includes the projection lens group 151 and the concave mirror 152.

The projection lens group 151 is that emits the light (the image light), emitted from the color separation and combination unit 140, toward the concave mirror 152.

The concave mirror 152 reflects the light (the image light) emitted from the projection lens group 151. The concave mirror 152 collects the image light and then widens an angle of the image light. For example, the concave mirror 152 is an aspherical mirror having a concave surface at the projection lens group 151-side.

The image light collected by the concave mirror 152 transmits the transmission area provided in the inclined plane 181 of the top plate concave unit 180 provided in the top plate 240. Preferably, the transmission area provided in the inclined plane 181 is provided around a position at which the image light is collected by the concave mirror 152.

As described above, the concave mirror 152 is located in a space formed by the front-side convex unit 170. For example, preferably, the concave mirror 152 is fixed at the inner side of the front-side convex unit 170. Furthermore, preferably, the inner side surface of the front-side convex unit 170 has a shape along the concave mirror 152.

Here, in the second embodiment, the color separation and combination unit 140 includes the optical diffuser 600 (a speckle noise reduction element) as described above. The optical diffuser 600 is a unit which is provided between the light source unit 110 and the DMD 500 on an optical path of the light emitted from the light source unit 110 and reduces speckle noise of the light emitted from the light source unit 110. In other words, the optical diffuser 600 is an optical element that reduces spatial coherence of the white light W in order to reduce a speckle. Specifically, the optical diffuser 600 diffuses the white light W uniformized by the rod integrator 10W and transmits the white light W. For example, the optical diffuser 600 may have the following configuration.

### First Configuration Example

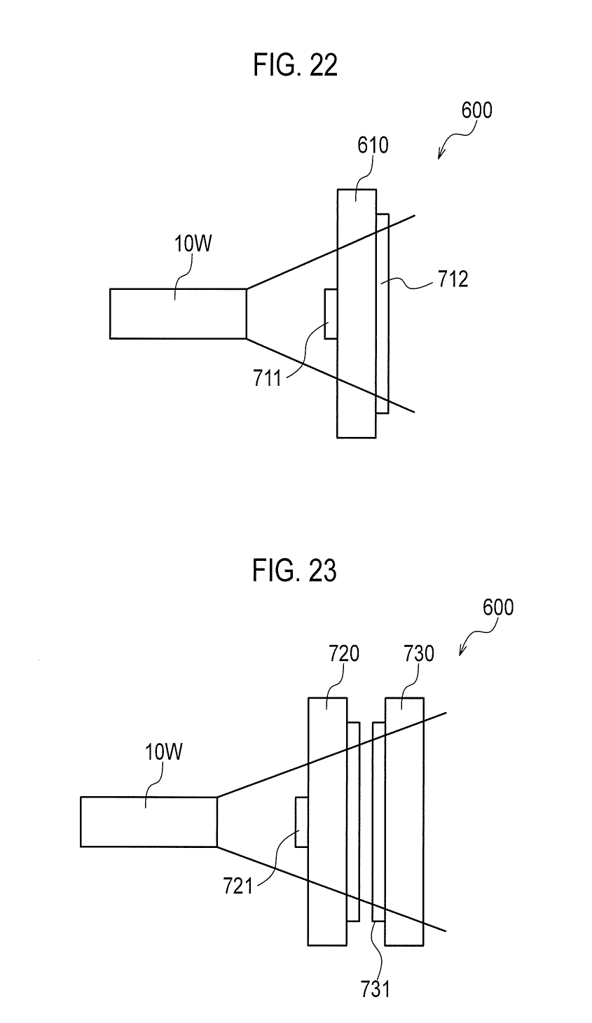

In the first configuration example, as illustrated in FIG. 22, the optical diffuser 600 includes a glass plate 710, a diffusion surface 711, and a diffusion surface 712.

The glass plate 710 is arranged between the light source unit 110 and the DMD 500 on an optical path of the light emitted from the light source unit 110. Specifically, in the second embodiment, the glass plate 710 is arranged at the light exit side of the rod integrator 10W.

The glass plate 710 has two main surfaces, and the two main surfaces are approximately perpendicular to the optical axis of the light emitted from the light source unit 110.

The diffusion surface 711 is provided on main one surface of the two main surfaces of the glass plate 710. Specifically, the diffusion surface 711 is provided on a main surface provided at the light source unit 110-side. Furthermore, the diffusion surface 711 is provided in a center area including an optical axis center of the light emitted from the light source unit 110. In addition, the diffusion surface 711 diffuses the light emitted from the light source unit 110 and transmits the light emitted from the light source unit 110.

The diffusion surface 712 is provided on the other main surface of the two main surfaces of the glass plate 710. Specifically, the diffusion surface 712 is provided on a main surface provided at an opposite side of the light source unit 110. Furthermore, the diffusion surface 712 is provided in a peripheral area around the center area including the optical axis center of the light emitted from the light source unit 110. In addition, the diffusion surface 712 diffuses the light emitted from the light source unit 110 and transmits the light emitted from the light source unit 110.

As described above, in the center area, the light emitted from the light source unit 110 is diffused by both of the diffusion surface 711 and the diffusion surface 712. In the peripheral area, the light emitted from the light source unit 110 is diffused only by the diffusion surface 712.

Thus, as the whole of the optical diffuser 600, the diffusion degree of the center area is larger than the diffusion degree of the peripheral area.

### Second Configuration Example

In the second configuration example, as illustrated in FIG. 23, the optical diffuser 600 includes a glass plate 720, a diffusion surface 721, a glass plate 730, and a diffusion surface 731.

The glass plate 720 has two main surfaces, and the two main surfaces are approximately perpendicular to the optical axis of the light emitted from the light source unit 110. In the same manner, the glass plate 730 has two main surfaces, and the two main surfaces are approximately perpendicular to the optical axis of the light emitted from the light source unit 110.

The diffusion surface 721 is provided on one main surface of the two main surfaces of the glass plate 720. For example, the diffusion surface 721 is provided on a main surface provided at the light source unit 110-side. Furthermore, the diffusion surface 721 is provided in a center area including an optical axis center of the light emitted from the light source unit 110. In addition, the diffusion surface 721 diffuses the light emitted from the light source unit 110 and transmits the light emitted from the light source unit 110. In addition, the diffusion surface 721 may also be provided on a main surface provided at an opposite side of the light source unit 110.

The diffusion surface 731 is provided on one main surface of the two main surfaces of the glass plate 730. For example, the diffusion surface 731 is provided on a main surface provided at the light source unit 110-side. Furthermore, the diffusion surface 731 is provided in a peripheral area around the center area including the optical axis center of the light emitted from the light source unit 110. In addition, the diffusion surface 731 diffuses the light emitted from the light source unit 110 and transmits the light emitted from the light source unit 110. In addition, the diffusion surface 731 may also be provided on a main surface provided at an opposite side of the light source unit 110.

As described above, in the center area, the light emitted from the light source unit 110 is diffused by both of the diffusion surface 721 and the diffusion surface 731. In the peripheral area, the light emitted from the light source unit 110 is diffused only by the diffusion surface 731.

Thus, as the whole of the optical diffuser 600, the diffusion degree of the center area is larger than the diffusion degree of the peripheral area.

### (Configuration of Control Unit)

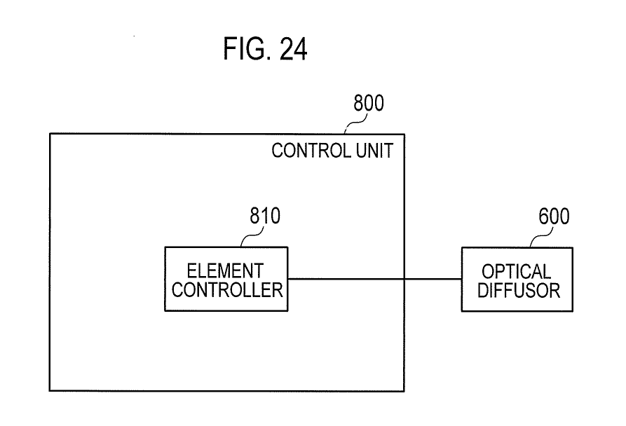

Hereinafter, the control unit according to the second embodiment will be described with reference to the accompanying drawings. FIG. 24 is a block diagram illustrating a control unit 800 according to the second embodiment. The control unit 800 is arranged in the projection display apparatus 100 and controls the projection display apparatus 100.

The control unit 800 converts the image input signal into an image output signal. The image input signal is configured by a red input signal Rᵢₙ, a green input signal Gᵢₙ, and a blue input signal Bᵢₙ. The image output signal is configured by a red output signal Rₒᵤₜ, a green output signal Gₒᵤₜ, and a blue output signal Bₒᵤₜ. The image input signal and the image output signal are signals to be input in a respective one of a plurality of pixels configuring one frame.

As illustrated in FIG. 24, the control unit 800 includes an element controller 810. The element controller 810 performs control so that the optical diffuser 600 operates in a predetermined operation pattern. For example, the element controller 810 vibrates the optical diffuser 600 in a predetermined operation pattern under the control of a driving device that drives the optical diffuser 600.

When the optical diffuser 600 corresponds to the second configuration example illustrated in FIG. 23, it is possible for the element controller 810 to independently control the glass plate 720 (the diffusion surface 721) and the glass plate 730 (the diffusion surface 731). In such a case, when a vibration phase of the diffusion surface 721 is set to φ and a vibration phase of the diffusion surface 731 is set to φ′, the control unit 800 may control the optical diffuser 600 so that a relation of Φ′≠Φ+nπ is satisfied.

### (Operation and Effect)

In the second embodiment, the optical diffuser 600 uniformizes the spatial distribution of light intensity on the exit pupil surface of the projection unit. Consequently, the intensities of the light beams reaching one point of the projection surface from the diaphragm surface (the exit pupil surface) of the projection unit show a uniform angle distribution, so that the speckle noise reduction effect due to the angle superposition can be sufficiently exhibited, thereby effectively removing speckle noise.

In addition, in the second embodiment, the optical diffuser 600 has a configuration in which the diffusion degree of the center area is larger than the diffusion degree of the peripheral area. That is, light passing through the center area of the optical diffuser 600 is further diffused as compared with light passing through the peripheral area of the optical diffuser 600. Thus, the spatial distribution of light intensity on the exit pupil surface of the projection unit is uniformized.

### (Description of Effect)

Hereinafter, the effect of the optical diffuser 600 according to the second embodiment will be described with reference to the accompanying drawings.

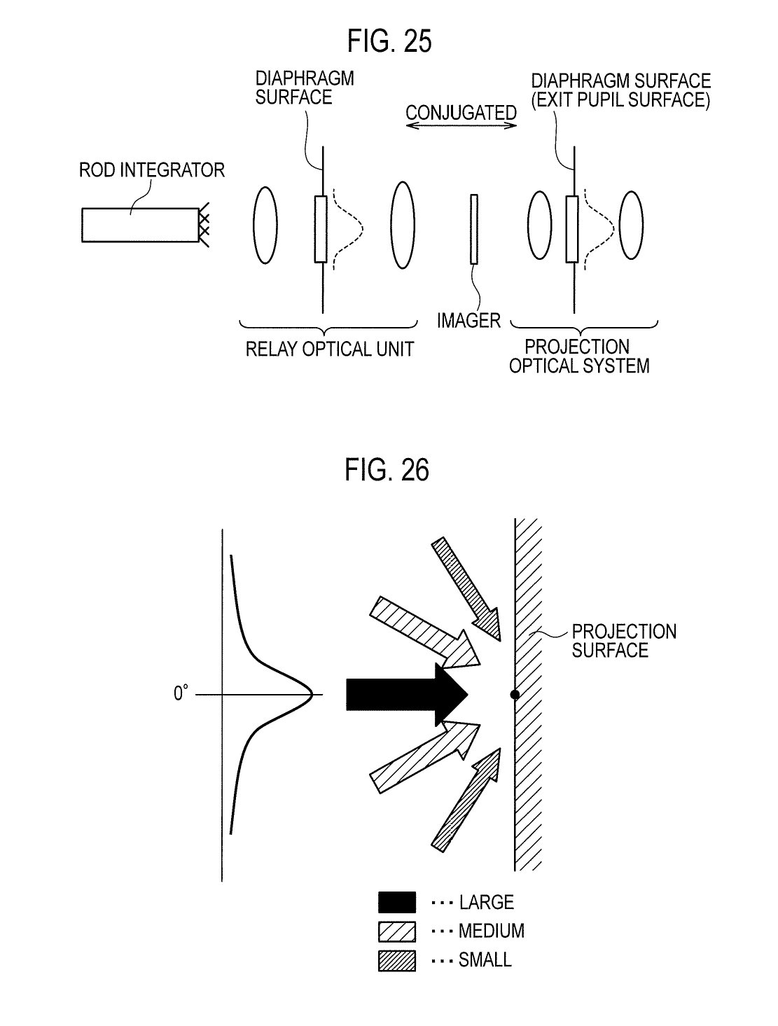

Firstly, in the case (the conventional technology) in which the optical diffuser 600 is not provided, the spatial distribution of light intensity will be described. FIG. 25 and FIG. 26 are diagrams explaining the spatial distribution of light intensity according to the conventional technology.

In addition, FIG. 25 schematically Illustrates an optical configuration provided in the projection display apparatus. Specifically, in FIG. 25, an optical path of light emitted from a light source (a rod integrator) is schematically illustrated in a linear shape. Furthermore, FIG. 25 illustrates a rod integrator, a relay optical unit, an imager, and a projection unit as the optical configuration provided in the projection display apparatus.

The angle distribution of the light emitted from the light source corresponds to Gaussian distribution in which 0 degrees is employed as a center. Furthermore, the diaphragm of the relay optical unit and the diaphragm (the exit pupil) of the projection unit have a conjugate relation.

As illustrated in FIG. 25, in the case in which the optical diffuser 600 is not provided, the spatial distribution of light intensity on the diaphragm surface of the relay optical unit and the diaphragm surface (the exit pupil surface) of the projection unit corresponds to Gaussian distribution reflecting the angle distribution of the light emitted from the light source.

Thus, when considering light flux reaching one point (a center point of the projection surface) of the projection surface from the diaphragm surface (the exit pupil surface) of the projection unit, the intensity of light flux reaching one point of the projection surface from the peripheral area is smaller than the intensity of light flux reaching one point of the projection surface from the center area. That is, the intensities of the light beams reaching one point of the projection surface do not show a uniform angle distribution.

As described above, in the conventional technology, since the intensities of the light beams reaching one point of the projection surface do not show a uniform angle distribution, the speckle noise reduction effect due to angle superposition may not be sufficiently exhibited, so that speckle noise may be observed.

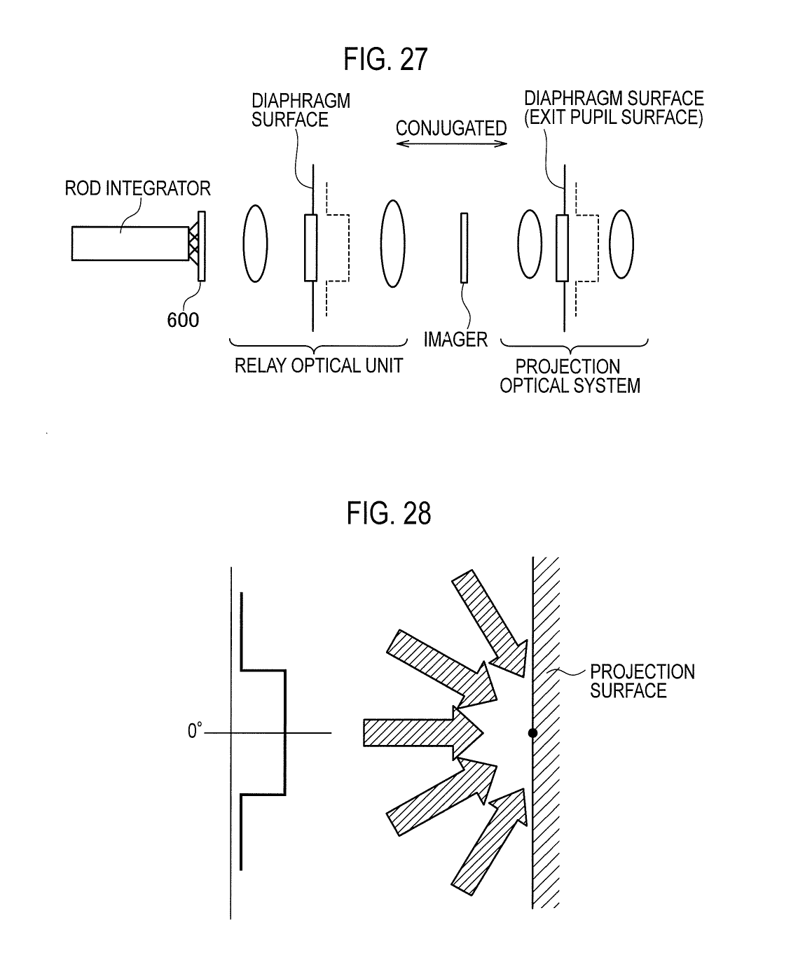

Secondly, in the case (the second embodiment) in which the optical diffuser 600 is provided, the spatial distribution of light intensity will be described. FIG. 27 and FIG. 28 are diagrams explaining the spatial distribution of light intensity according to the second embodiment.

In addition, FIG. 27 schematically illustrates an optical configuration provided in the projection display apparatus. Specifically, in FIG. 27, an optical path of light emitted from a light source (a rod integrator) is schematically illustrated in a linear shape. Furthermore, FIG. 27 illustrates a rod integrator (for example, the rod integrator 10W), a relay optical unit (the lens 21W, the lens 23, and the lens 40), an imager (for example, the DMD 500), and a projection unit (for example, the projection lens group 151) as the optical configuration provided in the projection display apparatus.

Similarly to the conventional technology, the angle distribution of the light emitted from the light source corresponds to Gaussian distribution in which 0 degrees is employed as a center. Furthermore, the diaphragm of the relay optical unit and the diaphragm (the exit pupil) of the projection unit have a conjugate relation.

As illustrated in FIG. 27, in the case in which the optical diffuser 600 is provided, the spatial distribution of light intensity on the diaphragm surface of the relay optical unit and the diaphragm surface (the exit pupil surface) of the projection unit is uniformized by the optical diffuser 600.

Thus, when considering the light flux reaching one point of the projection surface from the diaphragm surface (the exit pupil surface) of the projection unit, the intensities of the light beams reaching one point of the projection surface show uniform angle distribution as illustrated in FIG. 28.

As described above, in the second embodiment, the light passing through the center area of the optical diffuser 600 is further diffused as compared with the light passing through the peripheral area of the optical diffuser 600, so that the spatial distribution of light intensity on the diaphragm surface (the exit pupil surface) of the projection unit is uniformized. Consequently, the intensities of the light beams reaching one point of the projection surface show a uniform angle distribution, so that the speckle noise reduction effect due to angle superposition can be sufficiently exhibited and speckle noise can be efficiently removed.

### Overview of Third Embodiment

### Problem of Third Embodiment

If an optical diffusion element is provided on a divergent optical path of a projection display apparatus and vibrates in a direction parallel to the travel direction of light, since a divergence angle of the light is increased, light having an angle component not collected in a projection lens may be lost.

Furthermore, in order to prevent the light loss, it is necessary to use a projection lens with a small F value. However, in order to achieve sufficient imaging performance, the degree of difficulty is increased and a large-sized lens is necessary, resulting in an increase in the cost.

### Configuration of Third Embodiment

The projection display apparatus according to the third embodiment includes a light source unit formed of a coherent light source, a speckle noise reduction element that vibrates, swing or rotate to be approximately perpendicular to an optical axis of the light source unit in order to reduce speckle noise, an imager that modulates light emitted from the coherent light source, and a projection unit that projects light modulated by the imager, wherein the speckle noise reduction element includes a first lens array with a focal distance f and a second lens array with a focal distance f′, and an interval between media of the two lens arrays is approximately (f+f′)/n when an absolute refractive index is n.

The shape of the speckle noise reduction element has the first lens array with the focal distance f and the second lens array with the focal distance f′, and the interval between the media of the two lens arrays is approximately (f+f′)/n when the absolute refractive index is n. With such a configuration, an incident-side divergence angle of light incident upon the speckle noise reduction element may be equal to an exit-side divergence angle of light emitted from the speckle noise reduction element. Consequently, a divergence angle of light before being incident upon and after emerging from the speckle noise reduction element is prevented from being increased, so that an angle component not collected in a projection lens is rarely generated, resulting in a reduction of light loss of the projection display apparatus.

Furthermore, when the speckle noise reduction element arranged in an illumination optical system is vibrated, swung or rotated, the position and phase of each light ray emitted from the speckle noise reduction element change according to the passage of time. In this way, the angle and phase of each light ray incident upon each point on a screen surface change according to the passage of time, so that a speckle pattern is time-superimposed, resulting in a reduction of visible speckle noise.

Consequently, in the projection display apparatus using the coherent light source, speckle noise is reduced, thereby reducing light loss due to an increase in light divergence angle.

### Third Embodiment

### Configuration of Projection Display Apparatus

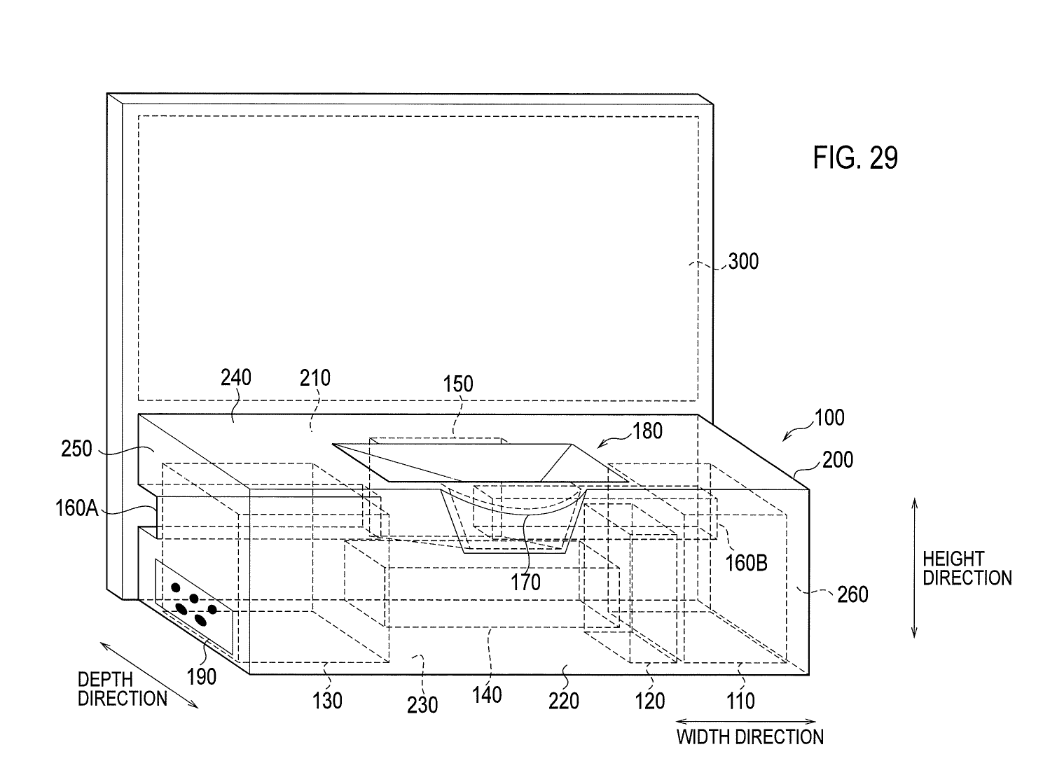

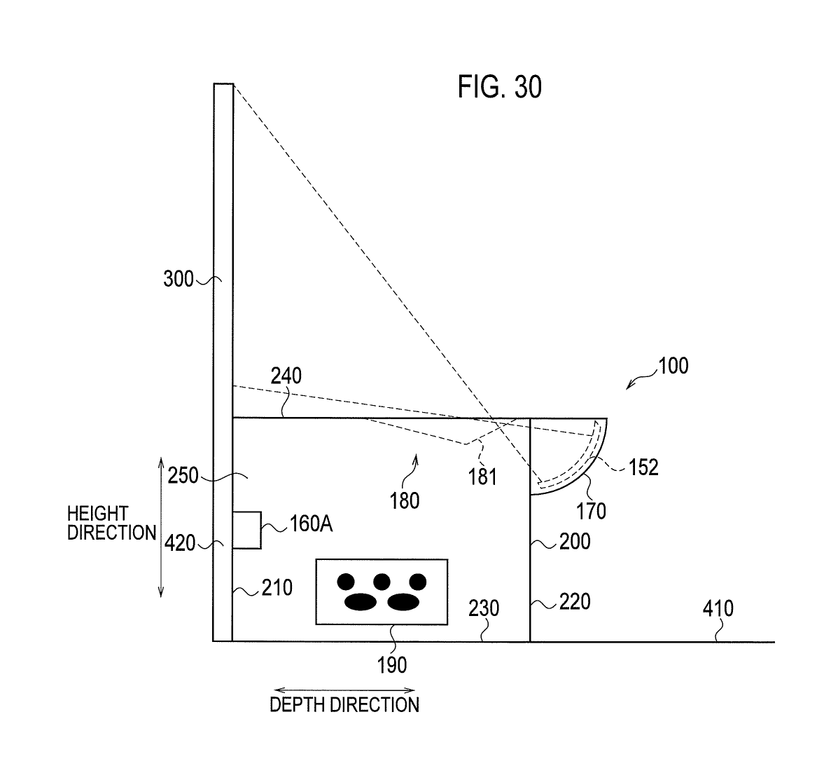

Hereinafter, the configuration of the projection display apparatus according to the third embodiment will be described with reference to the accompanying drawings. FIG. 29 is a perspective view illustrating a projection display apparatus 100 according to the third embodiment. FIG. 30 is a view in which the projection display apparatus 100 according to the third embodiment is seen from its side.

As illustrated in FIG. 29 and FIG. 30, the projection display apparatus 100 includes a housing member 200 and projects image onto a projection surface 300. The projection display apparatus 100 is arranged along a first arrangement surface (a wall surface 420 illustrated in FIG. 30) and a second arrangement surface (a floor surface 410 illustrated in FIG. 30) approximately perpendicular to the first arrangement surface.

Hereinafter, in the third embodiment, the case in which the projection display apparatus 100 projects image light onto the projection surface 300 provided to a wall surface will be described as an example (wall surface projection). In such a case, the arrangement of the housing member 200 will be called wall surface projection arrangement. In the third embodiment, the first arrangement surface approximately parallel to the projection surface 300 is the wall surface 420.

In the third embodiment, a horizontal direction parallel to the projection surface 300 will be called a “width direction”. A normal direction of the projection surface 300 will be called a “depth direction”. A direction perpendicular to both the width direction and the depth direction will be called a “height direction”.

The housing member 200 has an approximately rectangular parallelepiped shape. The size in the depth direction of the housing member 200 and the size in the height direction of the housing member 200 are smaller than the size in the width direction of the housing member 200. The size in the depth direction of the housing member 200 is approximately the same as a projection distance from a reflection mirror (a concave mirror 152 illustrated in FIG. 30) to the projection surface 300. In the width direction, the size of the housing member 200 is approximately the same as the size of the projection surface 300. In the height direction, the size of the housing member 200 is determined according to an installation position of the projection surface 300.

Specifically, the housing member 200 includes a projection surface-side sidewall 210, a front-side sidewall 220, a bottom plate 230, a top plate 240, a first side surface-side sidewall 250, and a second side surface-side sidewall 260.

The projection surface-side sidewall 210 is a plate-shaped member facing a first arrangement surface (the wall surface 420 in the third embodiment) which is approximately parallel to the projection surface 300. The front-side sidewall 22C is a plate-shaped member provided at an opposite side of the projection surface-side sidewall 210. The bottom plate 230 is a plate-shaped member facing the second arrangement surface (the floor surface 410 in the third embodiment) approximately perpendicular to the first arrangement surface approximately parallel to the projection surface 300. The top plate 240 is a plate-shaped member provided at an opposite side of the bottom plate 230. The first side surface-side sidewall 250 and the second side surface-side sidewall 260 are plate-shaped members forming both ends of the housing member 200 in the width direction.

The housing member 200 houses a light source unit 110, a power unit 120, a cooling unit 130, a color separation and combination unit 140, and a projection unit 150. The projection surface-side sidewall 210 has a projection surface-side concave unit 160A and a projection surface-side concave unit 160B. The front-side sidewall 220 has a front-side convex unit 170. The top plate 240 has a top plate concave unit 180. The first side surface-side sidewall 250 has a cable terminal 190.

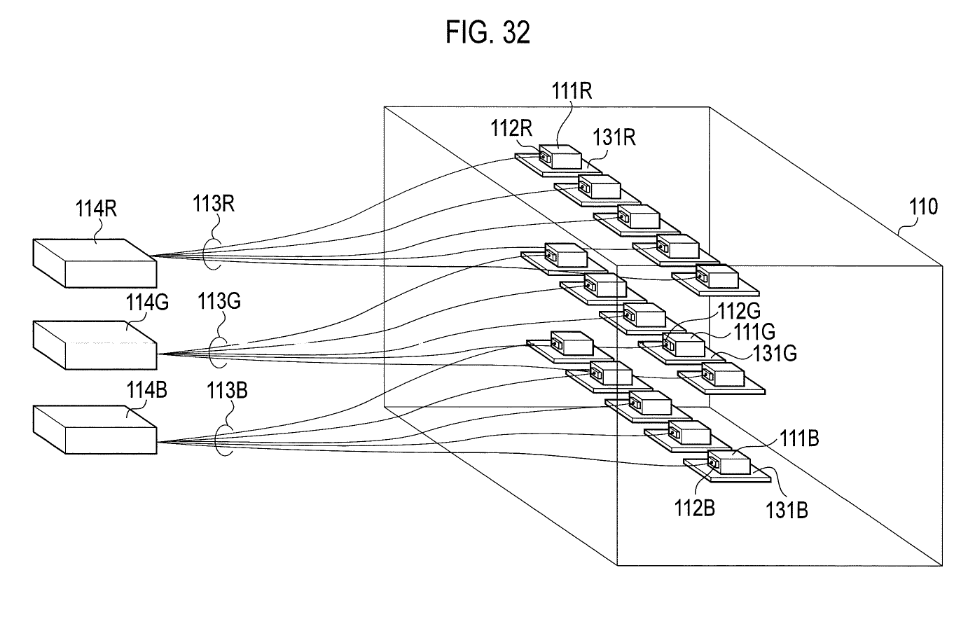

The light source unit 110 is formed of a plurality of coherent light sources (coherent light sources 111 illustrated in FIG. 32). Each coherent light source is a light source such as an LD (laser diode). In the third embodiment, the light source unit 110 includes a red coherent light source (a red coherent light source 111R illustrated in FIG. 32) that emits red component light R, a green coherent light source (a green coherent light source 111G illustrated in FIG. 32) that emits green component light G, and a blue coherent light source (a blue coherent light source 111B illustrated in FIG. 32) that emits blue component light B. Details of the light source unit 110 will be given later (see FIG. 32).

The power unit 120 supplies power to the projection display apparatus 100. For example, the power unit 120 supplies power to the light source unit 110 and the cooling unit 130.

The cooling unit 130 cools the plurality of coherent light sources provided in the light source unit 110. Specifically, the cooling unit 130 cools each coherent light source by cooling a cooling jacket (a cooling jacket 131 illustrated in FIG. 32) on which each coherent light source is placed.

In addition, the cooling unit 130 cools the power unit 120 and an imager (a DMD 500 which will be described later), in addition to each coherent light source.

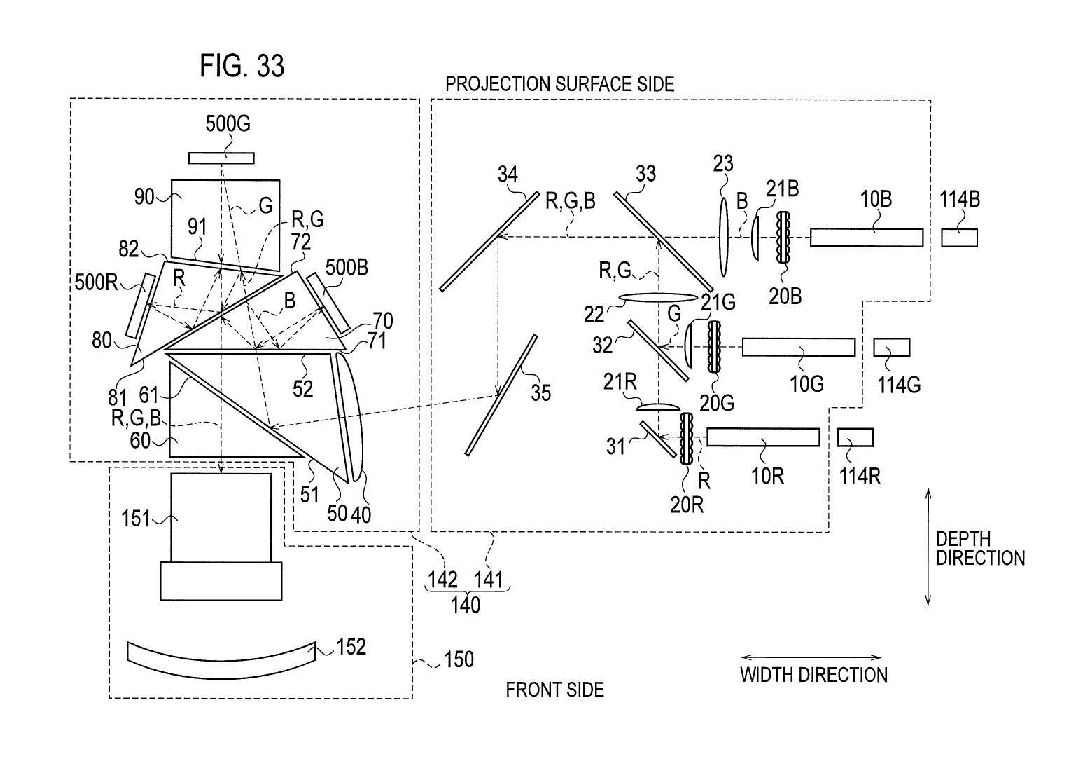

The color separation and combination unit 140 is that combines red component light R emitted from the red coherent light source, green component light G emitted from the green coherent light source, and blue component light B emitted from the blue coherent light source with one another. Moreover, the color separation and combination unit 140 separates a combined light including the red component light R, the green component light G, and the blue component light B from one another, and modulate the red component light R, the green component light G, and the blue component light B. Moreover, the color separation and combination unit 140 re-combines the red component light R, the green component light G, and the blue component light B with one another and output image light to the projection unit 150. Details of the color separation and combination unit 140 will be given later (see FIG. 33).

The projection unit 150 is that projects the light (the image light) emitted from the color separation and combination unit 140 onto the projection surface 300. Specifically, the projection unit 150 includes a projection lens group (a projection lens group 151 illustrated in FIG. 33) that projects the light emitted from the color separation and combination unit 140 onto the projection surface 300, and the reflection mirror (the concave mirror 152 illustrated in FIG. 33) that reflects light emitted from the projection lens group toward the projection surface 300. Details of the projection unit 150 will be given later.

The projection surface-side concave unit 160A and the projection surface-side concave unit 160B are provided in the projection surface-side sidewall 210, and are recessed inward the housing member 200. The projection surface-side concave unit 160A and the projection surface-side concave unit 160B extend up to an end of the housing member 200. The projection surface-side concave unit 160A and the projection surface-side concave unit 160B are provided with ventilation ports communicating with the inner side of the housing member 200.

In the third embodiment, the projection surface-side concave unit 160A and the projection surface-side concave unit 160B extend along the width direction of the housing member 200. For example, the projection surface-side concave unit 160A is provided with an inlet (the ventilation port) through which the air outside the housing member 200 flows into the housing member 200. The projection surface-side concave unit 160B is provided with an outlet (the ventilation port) through which the air inside the housing member 200 flows out of the housing member 200.

The front-side convex unit 170 is provided in the front-side sidewall 220 and protrudes outward the housing member 200. The front-side convex unit 170 is provided at approximately the center of the front-side sidewall 220 in the width direction of the housing member 200. In a space formed by the front-side convex unit 170 at the inner side of the housing member 200, the reflection mirror (the concave mirror 152 illustrated in FIG. 33) provided in the projection unit 150 is located.

The top plate concave unit 180 is provided in the top plate 240 and is recessed inward the housing member 200. The top plate concave unit 180 has an inclined plane 181 descending toward the projection surface 300. The inclined plane 181 has a transmission area where the light emitted from the projection unit 150 transmits (projects) toward the projection surface 300.

The cable terminal 190 is provided in the first side surface-side sidewall 250 and includes a power terminal, an image terminal and the like. In addition, the cable terminal 190 may also be provided in the second side surface-side sidewall 260.

### (Arrangement of Each Unit in the Width Direction of Housing Member)

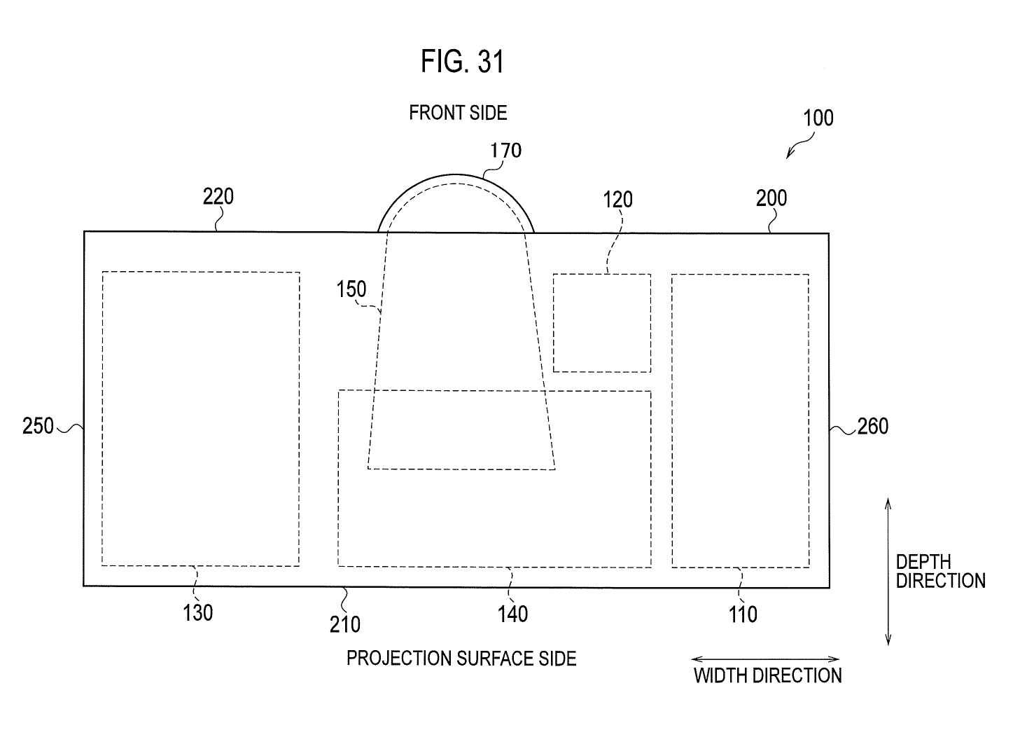

Hereinafter, the arrangement of each unit in the width direction according to the third embodiment will be described with reference to the accompanying drawing. FIG. 31 is a view in which the projection display apparatus 100 according to the third embodiment is seen from above.

As illustrated in FIG. 31, the projection unit 150 is arranged at approximately the center of the housing member 200 in the horizontal direction (in the width direction of the housing member 200) parallel to the projection surface 300.

The light source unit 110 and the cooling unit 130 are arranged in a line with the projection unit 150 in the width direction of the housing member 200. Specifically, the light source unit 110 is arranged in a line with one side (the second side surface-side sidewall 260-side) of the projection unit 150 in the width direction of the housing member 200. The cooling unit 130 is arranged in a line with the other side (the first side surface-side sidewall 250-side) of the projection unit 150 in the width direction of the housing member 200.

The power unit 120 is arranged in a line with the projection unit 150 in the width direction of the housing member 200. Specifically, the power unit 120 is arranged in a line with the light source unit 110-side with respect to the projection unit 150 in the width direction of the housing member 200. Preferably, the power unit 120 is arranged between the projection unit 150 and the light source unit 110.

### (Configuration of the Light Source Unit)

Hereinafter, the configuration of the light source unit according to the third embodiment will be described with reference to the accompanying drawing. FIG. 32 is a diagram illustrating the light source unit 110 according to the third embodiment.

As illustrated in FIG. 32, the light source unit 110 includes a plurality of red coherent light sources 111R, a plurality of green coherent light sources 111G, and a plurality of blue coherent light sources 111B.

As described above, the red coherent light source 111R is a red coherent light source such as an LD that emits red component light R. Each red coherent light source 111R has a head 112R, and an optical fiber 113R is connected to the head 112R.

The optical fibers 113R connected to the heads 112R of the red coherent light sources 111R are bundled by a bundle unit 114R. That is, light beams that emerge from the red coherent light sources 111R are transferred through the optical fibers 113R and are collected by the bundle unit 114R.

The red coherent light sources 111R are placed on a cooling jacket 131R. For example, the red coherent light sources 111R are fixed to the cooling jacket 131R by screwing and the like. Thus, the red coherent light sources 111R are cooled by the cooling jacket 131R.

As described above, the green coherent light source 111G is a green coherent light source such as an LD that emits green component light G. Each green coherent light source 111G has a head 112G, and an optical fiber 113G is connected to the head 112G.

The optical fibers 113G connected to the heads 112G of the green coherent light sources 111G are bundled by a bundle unit 114G. That is, light beams that emerge from the green coherent light sources 111G are transferred through the optical fibers 113G and are collected by the bundle unit 114G.

The green coherent light sources 111G are placed on a cooling jacket 131G. For example, the green coherent light sources 111G are fixed to the cooling jacket 131G by screwing and the like. Thus, the green coherent light sources 111G are cooled by the cooling jacket 131G.

As described above, the coherent light source 111B is a blue coherent light source such as an LD that emits blue component light B. Each blue coherent light source 111B has a head 112B, and an optical fiber 113B is connected to the head 112B.

The optical fibers 113B connected to the heads 112B of the blue coherent light sources 111B are bundled by a bundle unit 114B. That is, light beams that emerge from the blue coherent light sources 111B are transferred through the optical fibers 113B and are collected by the bundle unit 114B.

The blue coherent light sources 111B are placed on a cooling jacket 131B. For example, the blue coherent light sources 111B are fixed to the cooling jacket 131B by screwing and the like. Thus, the blue coherent light sources 111B are cooled by the cooling jacket 131B.

### (Configuration of Color Separation and Combination Unit and Projection Unit)

Hereinafter, the configuration of the color separation and combination unit and the projection unit according to the third embodiment will be described with reference to the accompanying drawing. FIG. 33 is a diagram illustrating the color separation and combination unit 140 and the projection unit 150 according to the third embodiment. In the third embodiment, the projection display apparatus 100 corresponding to a DLP (Digital Light Processing) scheme (a registered trademark) will be described as an example.

As illustrated in FIG. 33, the color separation and combination unit 140 includes a first unit 141 and a second unit 142.

The first unit 141 is that combines the red component light R, the green component light G, and the blue component light B with one another, and output a combined light including the red component light R, the green component light G, and the blue component light B to the second unit 142.

Specifically, the first unit 141 includes a plurality of rod integrators (a rod integrator 10R, a rod integrator 10G, and a rod integrator B), a lens group (a lens 21R, a lens 21G, a lens 21B, a lens 22, and a lens 23), and a mirror group (a mirror 31, a mirror 32, a mirror 33, a mirror 34, and a mirror 35).

The rod integrator 10R has a light incidence surface, a light exit surface, and a light reflection side surface provided from the outer periphery of the light incidence surface to the outer periphery of the light exit surface. The rod integrator 10R is that uniformizes the red component light R emitted from the optical fibers 113R bundled by the bundle unit 114R. That is, the rod integrator 10R is that uniformizes the red component light R by reflecting the red component light R at the light reflection side surface.

The rod integrator 10G has a light incidence surface, a light exit surface, and a light reflection side surface provided from the outer periphery of the light incidence surface to the outer periphery of the light exit surface. The rod integrator 10G is that uniformizes the green component light G emitted from the optical fibers 113G bundled by the bundle unit 114G. That is, the rod integrator 10G is that uniformizes the green component light G by reflecting the green component light G at the light reflection side surface.

The rod integrator 10B has a light incidence surface, a light exit surface, and a light reflection side surface provided from the outer periphery of the light incidence surface to the outer periphery of the light exit surface. The rod integrator 10B is that uniformizes the blue component light B emitted from the optical fibers 113B bundled by the bundle unit 114B. That is, the rod integrator 10B is that uniformizes the blue component light B by reflecting the blue component light B at the light reflection side surface.

In addition, the rod integrator 10E, the rod integrator 10G, and the rod integrator 10B may also be a hollow rod in which a light reflection side surface is formed of a mirror surface. Furthermore, the rod integrator 10R, the rod integrator 10G, and the rod integrator 10B may also be a solid rod formed of glass and the like.

A speckle noise reduction element 20R is arranged immediately after the light exit surface of the rod integrator 10R serving as an approximately conjugate surface to the imager and the screen surface, and periodically vibrates, swings, or rotates in a direction perpendicular to an optical axis of the red component light R from the rod integrator 10R. Here, the vibration indicates that an object reciprocates with respect to a specific one axis about an optical axis of light or reciprocates in parallel to the optical axis of the light, the swing indicates that an object approximately circularly moves in a surface perpendicular to the optical axis of the light, and the rotation indicates that an object rotates about a specific one axis parallel to the optical axis of the light. The speckle noise reduction element 20R periodically vibrates, swings, or rotates, so that the exit position and phase of each light ray may change according to the passage of time when the red component light R emitted from the rod integrator 20R exits after passing through the speckle noise reduction element 20R.

A speckle noise reduction element 20G is arranged immediately after the light exit surface of the rod integrator 10G serving as an approximately conjugate surface to the imager and the screen surface, and periodically vibrates, swings, or rotates in a direction perpendicular to an optical axis of the green component light G from the rod integrator 10G. The speckle noise reduction element 20G periodically vibrates, swings, or rotates, so that the exit position and phase of each light ray may change according to the passage of time when the red component light G emitted from the rod integrator 20G exits after passing through the speckle noise reduction element 20G.

A speckle noise reduction element 20B is arranged immediately after the light exit surface of the rod integrator 10B serving as an approximately conjugate surface to the imager and the screen surface, and periodically vibrates, swings, or rotates in a direction perpendicular to an optical axis of the blue component light B from the rod integrator 10B. The speckle noise reduction element 20B periodically vibrates, swings, or rotates, so that the exit position and phase of each light ray may change according to the passage of time when the green component light B emitted from the rod integrator 20B exits after passing through the speckle noise reduction element 20B.

Speckle noise represents a phenomenon that a coherent light such as a laser light beam is scattered at each point of a rough surface such as a screen, and scattered light beams interfere with each other with an irregular phase relation occurring by surface roughness and are observed as irregular granular intensity distribution. When the speckle noise reduction element arranged in the illumination optical system is vibrated, swung, or rotated, the position and phase of each light ray emitted from the speckle noise reduction element change according to the passage of time. In this way, the angle and phase of each light ray incident upon each point on a screen surface change according to the passage of time, so that a speckle pattern is time-superimposed, resulting in a reduction of visible speckle noise.

The lens 21R is a relay lens for relaying the red component light R so that the DMD 500R is illuminated with the red component light R. The lens 21G is a relay lens that relays the green component light G so that the DMD 500G is illuminated with the green component light G. The lens 21B is a relay lens that relays the blue component light B so that the DMD 500B is illuminated with the blue component light B.

The lens 22 is a relay lens for approximately focusing the red component light R and the green component light G onto the DMD 500R and the DMD 500G while suppressing the spread of the red component light R and the green component light G. The lens 23 is a relay lens for approximately focusing the blue component light B onto the DMD 500B while suppressing the spread of the blue component light B.

The mirror 31 reflects the red component light R emitted from the rod integrator 10R. The mirror 32 is a dichroic mirror that reflects the green component light G emitted from the rod integrator 10G and transmits the red component light R. The mirror 33 is a dichroic mirror that transmits the blue component light B emitted from the rod integrator 10B and reflects the red component light R and the green component light G.

The mirror 34 reflects the red component light R, the green component light G, and the blue component light B. The mirror 35 reflects the red component light R, the green component light G, and the blue component light B toward the second unit 142. In addition, in FIG. 33, each element is illustrated in a plan view for the purpose of convenience. However, the mirror 35 slantingly reflects the red component light R, the green component light G, and the blue component light B in the height direction.

The second unit 142 separates the combined light including the red component light R, the green component light G, and the blue component light B, and modulates the red component light R, the green component light G, and the blue component light B. Then, the second unit 142 re-combines the red component light R, the green component light G, and the blue component light B with one another, and outputs image light toward the projection unit 150.

Specifically, the second unit 142 includes a lens 40, a prism 50, a prism 60, a prism 70, a prism 80, a prism 90, and a plurality of DMDs (Digital Micromirror Devices; the DMD 500R, the DMD 500G, and the DMD 500B).

The lens 40 is a relay lens for relaying the light emitted from the first unit 141 so that each DMD is illuminated with each component light.

The prism 50 is formed of a light transmitting member and has a plane 51 and a plane 52. Since an air gap is provided between the prism 50 (the plane 51) and the prism 60 (a plane 61) and an angle (an incident angle) at which the light emitted from the first unit 141 is incident upon the plane 51 is larger than the total reflection angle, the light emitted from the first unit 141 is reflected at the plane 51. Meanwhile, since an air gap is provided between the prism 50 (the plane 52) and the prism 70 (a plane 71) but an angle (an incident angle) at which the light emitted from the first unit 141 is incident upon the plane 52 is smaller than the total reflection angle, the light reflected at the plane 51 transmits the plane 52.

The prism 60 is formed of a light transmitting member and has the plane 61.

The prism 70 is formed of a light transmitting member and has a plane 71 and a plane 72. Since an air gap is provided between the prism 50 (the plane 52) and the prism 70 (the plane 71) and an angle (an incident angle) at which blue component light B reflected at the plane 72 and blue component light B emitted from the DMD 500B are incident upon the plane 71 is larger than the total reflection angle, the blue component light B reflected at the plane 72 and the blue component light B emitted from the DMD 500B are reflected at the plane 71.

The plane 72 is a dichroic mirror surface that transmits red component light R and green component light G and reflects blue component light B. Thus, among the beams reflected at the plane 51, the red component light R and the green component light G transmits the plane 72, and the blue component light B is reflected at the plane 72. The blue component light B reflected at the plane 71 is reflected at the plane 72.

The prism 80 is formed of a light transmitting member and has a plane 81 and a plane 82. Since an air gap is provided between the prism 70 (the plane 72) and the prism 80 (the plane 81) and an angle (an incident angle) at which red component light R reflected at the plane 82 by transmitting the plane 81 and red component light R emitted from the DMD 500R are again incident upon the plane 81 is larger than the total reflection angle, the red component light R reflected at the plane 82 by transmitting the plane 81 and the red component light R emitted from the DMD 500R are reflected at the plane 81. Meanwhile, since an angle (an incident angle) at which the red component light R reflected at the plane 82 after emerging from the DMD 500R and reflected at the plane 81 is again incident upon the plane 81 is smaller than the total reflection angle, the red component light R reflected at the plane 82 after emerging from the DMD 500R and reflected at the plane 81 transmits the plane 81.

The plane 82 is a dichroic mirror surface that transmits the green component light G and reflects the red component light R. Thus, among the light beams having transmitted the plane 81, the green component light G transmits the plane 82 and the red component light R is reflected at the plane 82. The red component light R reflected at the plane 81 is reflected at the plane 82. A green component light G emitted from the DMD 500G transmits the plane 82.

Here, the prism 70 separates a combined light including the red component light R and the green component light G from the blue component light B using the plane 72. The prism 80 separates the red component light R from the green component light G using the plane 82. That is, the prism 70 and the prism 80 function as color separating elements that separates each color component light.

In addition, in the third embodiment, a cut-off wavelength of the plane 72 of the prism 70 exists between a waveband corresponding to a green color and a waveband corresponding to a blue color. A cut-off wavelength of the plane 82 of the prism 80 is provided between a waveband corresponding to the red color and a waveband corresponding to the green color.

Meanwhile, the prism 70 combines the combined light including the red component light R and the green component light G with the blue component light B using the plane 72. The prism 80 combines the red component light R with the green component light G using the plane 82. That is, the prism 70 and the prism 80 function as color combining elements that combines each color component light.

The prism 90 is formed of a light transmitting member and has the plane 91. The plane 91 transmits the green component light G. In addition, the green component light G incident upon the DMD 500G and the green component light G emitted from the DMD 500G pass through the plane 91.

The DMD 500R, the DMD 500G, and the DMD 500B are formed of a plurality of micromirrors, respectively, and the plurality of micromirrors are a movable type. Each micromirror basically corresponds to one pixel. The DMD 500R changes an angle of each micromirror to switch whether to reflect the red component light R toward the projection unit 150. In the same manner, the DMD 500G and the DMD 500B change the angle of each micromirror to switch whether to reflect green component light G and the blue component light B toward the projection unit 150.

The projection unit 150 includes the projection lens group 151 and the concave mirror 152.

The projection lens group 151 is that emits the light (the image light), emitted from the color separation and combination unit 140, toward the concave mirror 152.

The concave mirror 152 reflects the light (the image light) emitted from the projection lens group 151. The concave mirror 152 collects the image light and then widens an angle of the image light. For example, the concave mirror 152 is an aspherical mirror having a concave surface at the projection lens group 151-side.

The image light collected by the concave mirror 152 transmits the transmission area provided in the inclined plane 181 of the top plate concave unit 180 provided in the top plate 240. Preferably, the transmission area provided in the inclined plane 181 is provided around a position at which the image light is collected by the concave mirror 152.

As described above, the concave mirror 152 is located in the space formed by the front-side convex unit 170. For example, preferably, the concave mirror 152 is fixed at the inner side of the front-side convex unit 170. Furthermore, preferably, the inner side surface of the front-side convex unit 170 has a shape along the concave mirror 152.

### (Basic Configuration of Speckle Noise Reduction Element)

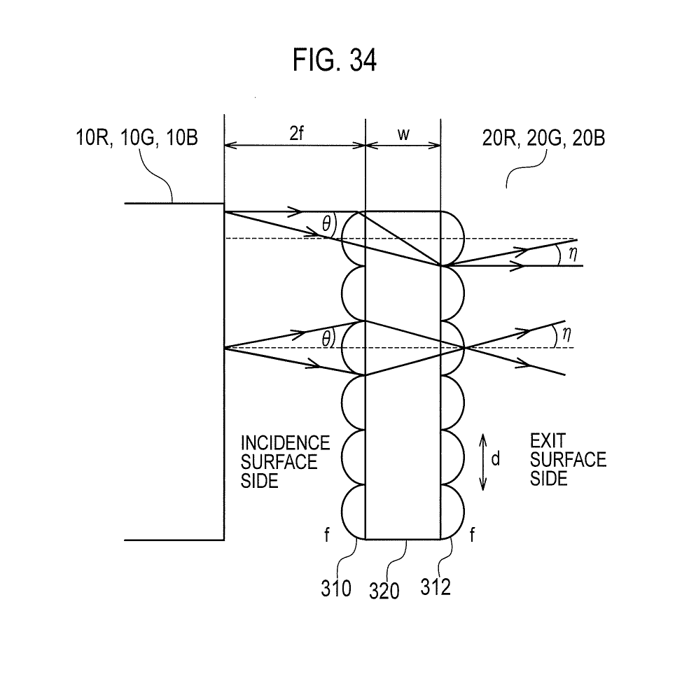

FIG. 34 is a detailed diagram illustrating the speckle noise reduction element 20R, the speckle noise reduction element 20G, and the speckle noise reduction element 20B. The speckle noise reduction element 20R, the speckle noise reduction element 20G, and the speckle noise reduction element 20B are provided with an incident-side micro lens array 310, an element board 320, an exit-side micro lens array 312, and a vibration-applying unit (not illustrated).

The incident-side micro lens array 310 is a collection of hemispheric micro lenses innumerably formed at the light incident surface-sides of the speckle noise reduction element 20R, the speckle noise reduction element 20G, and the speckle noise reduction element 20B. Each lens of the incident-side micro lens array 310 is a micro lens with a refractive index n and a focal distance f.

The incident-side micro lens array 310 and the exit-side micro lens array 312 adhere to the element board 320 by ultraviolet cure adhesive. The element board 320 is a transparent board with a refractive index n and a thickness W. In addition, the thickness W of the element board 320 is “2f/n”±“error”. In other words, the thickness W of the element board 320 may not be strictly equal to “2f/n”, or it is sufficient if the thickness W of the element board 320 is approximately equal to “2f/n”.

The exit-side micro lens array 312 is a collection of hemispheric micro lenses innumerably formed at the light exit surface-sides of the speckle noise reduction element 20R, the speckle noise reduction element 20G, and the speckle noise reduction element 20B. Each lens of the exit-side micro lens array 312 is a micro lens with a refractive index n and a focal distance f.

Note that the incident-side micro lens array 310 and the exit-side micro lens array 312 adhere to the element board 320 by ultraviolet cure adhesive. However, the present invention is not limited thereto. The incident-side micro lens array 310, the element board 320, and the exit-side micro lens array 312 may also be integrally formed with one another. In this way, it is not necessary to stick the incident-side micro lens array 310, the element board 320, and the exit-side micro lens array 312 to one another or perform optical axis adjustment.

Next, an optical path of light traveling through the speckle noise reduction element 20R, the speckle noise reduction element 20G, and the speckle noise reduction element 20B will be described with reference to FIG. 34. Lights beams emitted from the exit end surfaces of the rod integrator 10R, the rod integrator 10G, and the rod integrator 10B are incident upon the incident-side micro lens array 310 spaced apart from the rod integrators by the distance 2f. The light beams incident upon the incident-side micro lens array 310 are refracted and pass through the incident-side micro lens array 310 and the element board 320. Here, the refraction occurs only in the incident surface of the incident-side micro lens array 310, and does not occur in a boundary surface between the incident-side micro lens array 310 and the element board 320, which have the same refractive index.

Since the thickness of the element board 320 is approximately 2f/n, the light having passed through the element board 320 is imaged on the exit-side micro lens array 312 adhering to the exit-side of the element board 320.

Since the focal distance of the exit-side micro lens array 312 is f which is the same as the incident-side micro lens array 310, an incident-side divergence angle θ and an exit-side divergence angle η are equal to each other.

As described above, since the incident-side divergence angle θ is equal to the exit-side divergence angle η, light having an angle that cannot be fetched in the projection lens 151 is rarely generated, resulting in the prevention of light loss used for projection image.

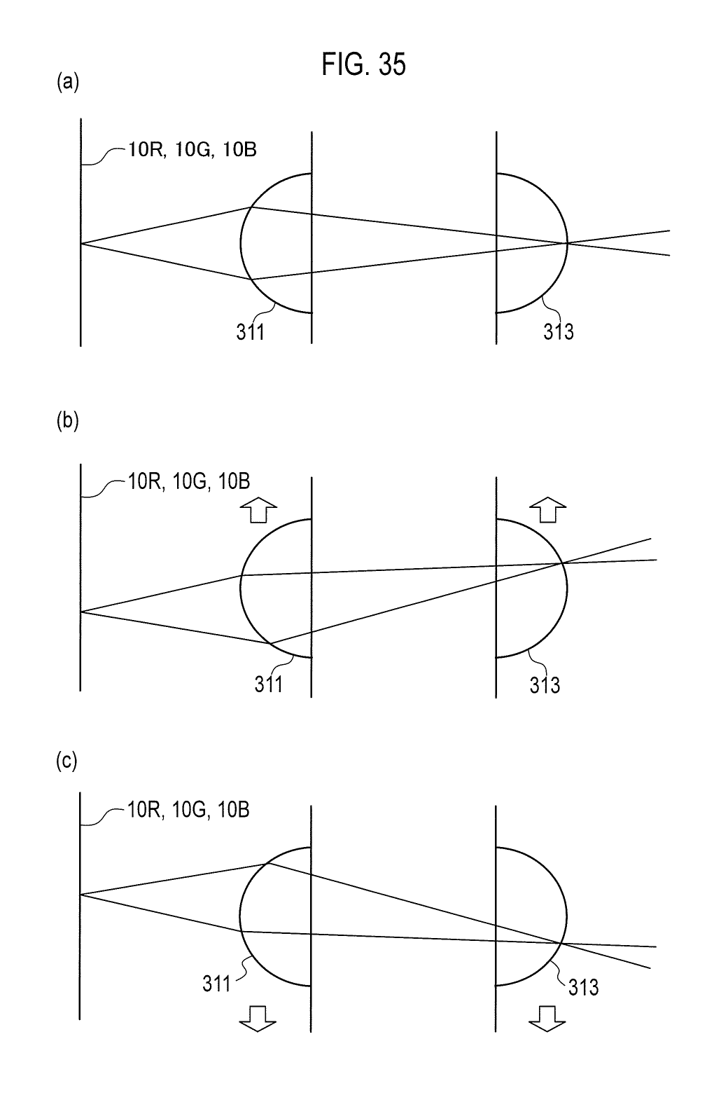

Next, a phenomenon, in which when the speckle noise reduction element 20R, the speckle noise reduction element 20G, and the speckle noise reduction element 20B are vibrated, swung, or rotated, the optical path length of incident light changes according to the passage of time, and the exit position and phase of light emitted from the speckle noise reduction element change according to the passage of time, will be described with reference to FIGS. 35 (a) to (c).

FIG. 35 (a) is a diagram emphasizing a pair of micro lenses which are the incident-side micro lens array 310 and the exit-side micro lens array 312.

The light beams that emerge from the exit end surfaces of the rod integrator 10R, the rod integrator 10G, and the rod integrator 10B are incident upon an incident-side micro lens 311 spaced apart from the rod integrators by the distance 2f. The light beams incident upon the incident-side micro lens 311 are refracted and pass through the incident-side micro lens 311 and the element board 320. Here, the refraction occurs only in the incident surface of the incident-side micro lens 311, and does not occur in a boundary surface between the incident-side micro lens 311 and the element board 320, which have the same refractive index.

Since the thickness of the element board 320 is approximately 2f/n, the light having passed through the element board 320 is imaged on the center of the exit-side micro lens 313 adhering to the exit-side of the element board 320.

FIG. 35 (b) is a diagram illustrating an optical path of light when the speckle noise reduction element 20R, the speckle noise reduction element 20G, and the speckle noise reduction element 20B have moved upward through vibration, as compared with FIG. 35 (a).

FIG. 35 (c) is a diagram illustrating an optical path of light when the speckle noise reduction element 20R, the speckle noise reduction element 20G, and the speckle noise reduction element 20B have moved downward through vibration, as compared with FIG. 35 (a).

For example, if the speckle noise reduction element 20R, the speckle noise reduction element 20G, and the speckle noise reduction element 20B vibrate up and down, the exit positions of exit light beams of the exit-side micro lenses are different from one another in FIGS. 35 (a) to (c). Furthermore, if the speckle noise reduction element 20R, the speckle noise reduction element 20G, and the speckle noise reduction element 20B vibrate up and down, light beams having passed through different optical path lengths in FIGS. 35 (a) to (c) are imaged. Thus, the light beams that emerge from the exit-side micro lenses emerge from the speckle noise reduction element 20R, the speckle noise reduction element 20G, and the speckle noise reduction element 20B as light beams with different phases.

In this way, the angle and phase of each light ray incident upon each point on the screen surface change according to the passage of time, so that a speckle pattern is time-superimposed, resulting in a reduction of visible speckle noise.

### (Applied Configuration of Speckle Noise Reduction Element)

Returning to FIG. 34, the micro lenses of the speckle noise reduction element 20R, the speckle noise reduction element 20G, and the speckle noise reduction element 20B will be described in detail. If all light beams that emerge from the distance of 2f are in the range of the incident-side divergence angle θ, the speckle noise reduction element 20R, the speckle noise reduction element 20G, and the speckle noise reduction element 20B may output all incident light beams in the range of the exit-side divergence angle η. That is, if diameters of the incident-side micro lens 311 and the exit-side micro lens 313 are set to d, the incident-side divergence angle θ is equal to the exit-side divergence angle η when the following conditions are satisfied.

$$\begin{matrix}[ Equation 1 ] & \\ tan θ < \frac{d}{4 f} & ( 1 ) \\ [ Equation 2 ] & \\ f < \frac{d}{4 tan θ} & ( 2 )\end{matrix}$$

Under the above conditions, if the diameters of the incident-side micro lens 311 and the exit-side micro lens 313 are designed, the incident-side divergence angle θ is equal to the exit-side divergence angle η as compared with the basic configuration of the speckle noise reduction element, so that light having an angle that cannot be fetched in the projection lens is rarely generated, resulting in the prevention of light loss used for projection image.

So far, the embodiment has a configuration in which the element board 320 is arranged between the incident-side micro lens array 310 and the exit-side micro lens array 312. However, the present invention is not limited thereto. For example, the incident-side micro lens array 310 and the exit-side micro lens array 312 may be independently arranged, and the incident-side micro lens array 310 and the exit-side micro lens array 312 may be spaced apart from the element board 320 by the distance 2f, respectively.

### First Modification

Hereinafter, the first modification of the third embodiment will be described with reference to the accompanying drawing. The description below is based primarily on the differences from the third embodiment.

Specifically, in the third embodiment, the light source unit 110 includes the red coherent light source 111R, the green coherent light source 111G, and the blue coherent light source 111B, the color separation and combination unit 140 includes the rod integrator 10R, the rod integrator 10G, and the rod integrator 10B, and the speckle noise reduction element R20, the speckle noise reduction element G20, and the speckle noise reduction element B20 are arranged immediately before the light exit surfaces of the rod integrator 10R, the rod integrator 10G, and the rod integrator 10B which serve as surfaces approximately conjugated to the screen surface.

On the other hand, in the first modification, the light source unit 110 includes a white coherent light source, the color separation and combination unit 140 includes a single number of rod integrator 10W, and the speckle noise reduction element W20 is arranged immediately before the light exit surface of the rod integrator 10W which serves as a surface approximately conjugated to the screen surface.

### Second Modification

Hereinafter, the first modification of the third embodiment will be described with reference to the accompanying drawing. The description below is based primarily on the differences from the third embodiment.

Specifically, in the third embodiment, the incident-side micro lens array 310 and the exit-side micro lens array 312 have the same focal distance f. In the second modification, the case, in which the focal distance of the exit-side micro lens array 312 is difficult from the focal distance f of the incident-side micro lens array 310 (is the focal distance f′), will be described.

The light beams incident upon the incident-side micro lens array 310 are refracted and pass through the incident-side micro lens array 310 and the element board 320. Since the focal distance of the exit-side micro lens array 312 is f′, if the thickness of the element board 320 is approximately set to (f+f)/n, the light having passed through the element board 320 is imaged on the exit-side micro lens array 312 adhering to the exit-side of the element board 320.

Here, a relation between the focal distance f and the focal distance f′ satisfies f≦f′. In this way, a relation between the incident-side divergence angle θ and the exit-side divergence angle η satisfies θ≧η. Thus, light having an angle that cannot be fetched in the projection lens 151 is rarely generated, resulting in the prevention of light loss used for projection image.

Furthermore, when the incident-side micro lens array 310 includes (n×m) micro lenses, the exit-side micro lens array 312 needs to have (n×m) micro lenses.

### (Configuration of Color Separation and Combination Unit and Projection Unit)

Hereinafter, the configuration of the color separation and combination unit and the projection unit according to the first modification will be described with reference to the accompanying drawing. FIG. 35 is a diagram illustrating the color separation and combination unit 140 and the projection unit 150 according to the first modification. In FIG. 35, the same reference numerals are used to designate the same elements as FIG. 33.

As illustrated in FIG. 35, instead of the speckle noise reduction element R20, the speckle noise reduction element G20, and the speckle noise reduction element B20, the color separation and combination unit 140 includes a speckle reduction element W20. Furthermore, instead of the rod integrator 10R, the rod integrator 10G, and the rod integrator 10B, the color separation and combination unit 140 includes a rod integrator 10W. Furthermore, instead of the lens 21R, the lens 21G, and the lens 21B, the color separation and combination unit 140 includes the lens 21W.

White light W is incident upon the rod integrator 10W from a bundle unit 114W. Here, it should be noted that the white light W emerges from the bundle unit 114W.

For example, the bundle unit 114W may also bundle an optical fiber through which white light emitted from a light source (an LD and the like) is transferred. In such a case, as a plurality of coherent light sources, provided are a plurality of coherent light sources that output white light.

Furthermore, the bundle unit 114W may also bundle an optical fiber 113R, an optical fiber 113G, and an optical fiber 113B. In such a case, similarly to the third embodiment, as a plurality of coherent light sources, provided are a red coherent light source 111R, a green coherent light source 111G, and a blue coherent light source 111B.

The lens 21W is a relay lens for relaying the white light so that the DMD 500 is illuminated with the white light.

### Fourth Embodiment

Hereinafter, the fourth embodiment will be described with reference to the accompanying drawing. The description below is based primarily on the differences from the third embodiment.

Specifically, in the third embodiment, the case in which the projection display apparatus 100 projects image light onto the projection surface 300 provided to a wall surface has been described as an example. On the other hand, in the fourth embodiment, the case in which the projection display apparatus 100 projects image light onto the projection surface 300 provided to a floor surface has been described as an example (floor surface projection). In such a case, the arrangement of a housing member 200 will be called floor projection arrangement.

### (Configuration of Projection Display Apparatus)

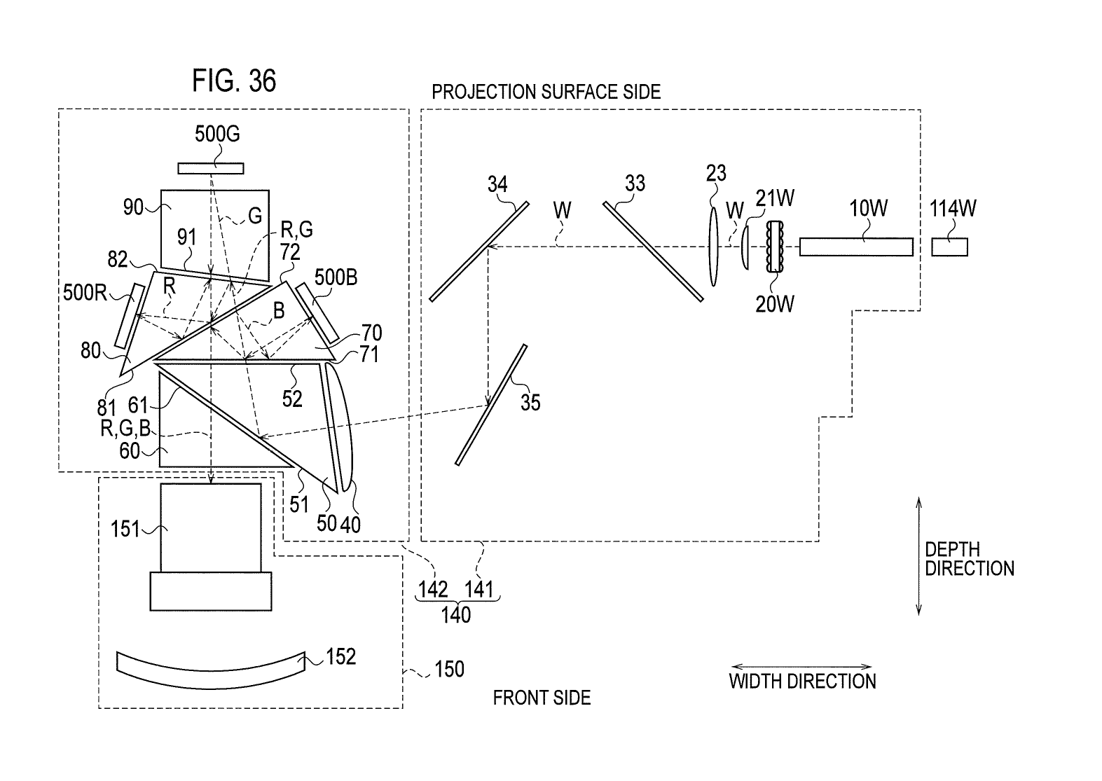

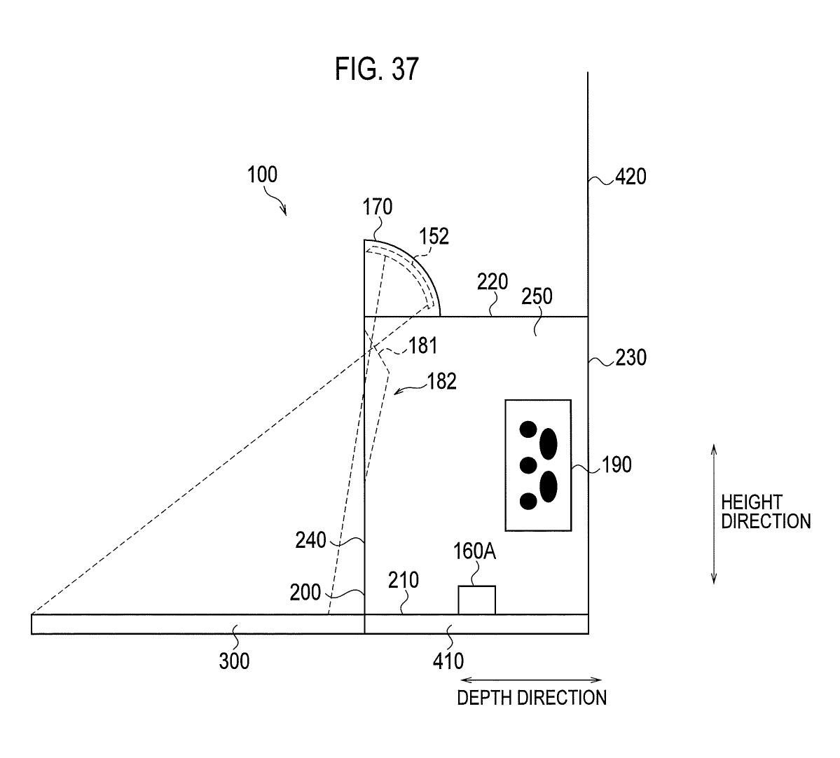

Hereinafter, the configuration of the projection display apparatus according to the fourth embodiment will be described with reference to the accompanying drawings. FIG. 36 is a side view illustrating the projection display apparatus 100 according to the fourth embodiment.

As illustrated in FIG. 36, the projection display apparatus 100 projects image light onto a projection surface 300 provided to a floor surface will be described as an example (floor surface projection). In the fourth embodiment, a first arrangement surface approximately parallel to the projection surface 300 is a floor surface 410. A second arrangement surface approximately perpendicular to the first arrangement surface is a wall surface 420.

In the fourth embodiment, a horizontal direction parallel to the projection surface 300 will be called a “width direction”. A normal direction of the projection surface 300 will be called a “height direction”. A direction perpendicular to both the width direction and the height direction will be called a “depth direction”.

Similarly to the third embodiment, in the fourth embodiment, the housing member 200 has an approximately rectangular parallelepiped shape. The size in the depth direction of the housing member 200 and the size in the height direction of the housing member 200 are smaller than the size in the width direction of the housing member 200. The size in the height direction of the housing member 200 is approximately the same as a projection distance from a reflection mirror (the concave mirror 152 illustrated in FIG. 30) to the projection surface 300. In the width direction, the size of the housing member 200 is approximately the same as the size of the projection surface 300. In the depth direction, the size of the housing member 200 is determined according to the distance from the wall surface 420 to the projection surface 300.

A projection surface-side sidewall 210 is a plate-shaped member facing the first arrangement surface (the floor surface 410 in the fourth embodiment) which is approximately parallel to the projection surface 300. The front-side sidewall 220 is a plate-shaped member provided at an opposite side of the projection surface-side sidewall 210. The top plate 240 is a plate-shaped member provided at an opposite side of the bottom plate 230. The bottom plate 230 is a plate-shaped member facing the second arrangement surface (the wall surface 420 in the fourth embodiment) other than the first arrangement surface which is approximately parallel to the projection surface 300. The first side surface-side sidewall 250 and the second side surface-side sidewall 260 are plate-shaped members forming both ends of the housing member 200 in the width direction. In the fourth embodiment, a red coherent light source, a green coherent light source, and a blue coherent light source may be used, or a white coherent light source may be used.

### Other Embodiments

While the present invention has been described by way of the foregoing embodiments, as described above, it should not be understood that the statements and drawings forming part of this disclosure limits the invention. Further, various substitutions, examples or operational techniques shall be apparent to a person skilled in the art based on this disclosure.

In the embodiments, the case in which one or two diffusion surfaces are provided on the optical path of the light emitted from the light source unit 110 has been described. However, three diffusion surfaces may also be provided on the optical path of the light emitted from the light source unit 110. In such a case, among the three diffusion surfaces, it is sufficient if at least two diffusion surfaces vibrate.

In the embodiments, the case in which the light source unit 110 includes the solid light source 111W for outputting white light W has been described. However, the embodiment is not limited thereto. For example, the light source unit 110 may also include a red solid light source for outputting red component light R, a green solid light source for outputting green component light G, and a blue solid light source for outputting blue component light B. In such a case, the optical diffuser 600 is arranged on the optical paths of the red component light R, the green component light G, and the blue component light B.

In the embodiments, the projection display apparatus 100 corresponding to a DLP scheme (a registered trademark) has been described. Furthermore, in the embodiments, the projection display apparatus 100 for performing wall surface projection has been described. However, the embodiments can also be applied to all projection display apparatuses if they use a light source for outputting light having coherency.

In the first embodiment, the case in which a mode is selected according to the distance between a screen and a viewer has been described. However, the embodiment is not limited thereto. For example, the size (the degree of zoom) and luminance of a projection image, the type of a screen and the like may be detected, and then the mode may be selected according to the distance between the screen and the viewer and a detection result.

In the second embodiment, the optical diffuser 600 is provided at the light exit side of the rod integrator 10W. However, the embodiment is not limited thereto. For example, the optical diffuser 600 may also be provided at the light incidence side of the rod integrator 10W.

In the second embodiment, as an example of the uniformization optical element, the optical diffuser 600 has been described. However, the embodiment is not limited thereto. As the uniformization optical element, all optical elements may also be used if they uniformize the spatial distribution of light intensity on the exit pupil surface of the projection unit. For example, the uniformization optical element may also include a diffraction grating or a micro lens array. For the diffraction grating, a diffraction pattern (a concave-convex pattern) of the diffraction grating is designed so that the spatial distribution of light intensity on the exit pupil surface of the projection unit is uniformized. For the micro lens array, the micro lens array is designed so that a curvature radius (R) in a center area of a lens is smaller than a curvature radius (R) in a peripheral area of the lens. That is, if the curvature radius (R) in the center area of the lens is small, the degree of light diffusion is increased, and if the curvature radius in the peripheral area of the lens is large, the degree of light diffusion is decreased.

In the second embodiment, the case in which the optical diffuser 600 has a center area and a peripheral area has been described. However, the present embodiment is not limited thereto. The distribution of the diffusion degree of the optical diffuser 600 may also be designed so that the spatial distribution of light intensity on the exit pupil surface of the projection unit is uniformized. For example, the diffusion degree of the optical diffuser 600 may also be gradually decreased outward the center thereof.

Furthermore, an area (for example, an area where is larger than ½ of the maximum intensity) where the intensity of light emitted from a light source is large may be set as the center area, and an area (for example, an area where is smaller than ½ of the maximum intensity) where the intensity of the light emitted from the light source is small may be set as the peripheral area. Preferably, the size of the center area is smaller than the size of the light exit surface of the rod integrator 10W.

In the third embodiment, the projection surface 300 is provided on the wall surface 420 on which the housing member 200 is arranged. However, the present embodiment is not limited thereto. The projection surface 300 may also be provided at a recessed position, as compared with the wall surface 420, in the direction away from the housing member 200.

In the fourth embodiment, the projection surface 300 is provided on the floor surface 410 on which the housing member 200 is arranged. However, the present embodiment is not limited thereto. The projection surface 300 may also be provided at a lower position as compared with the floor surface 410.

In the embodiments, as the imager, a DMD (Digital Micromirror Device) has been described as an example. The imager may be a transparent liquid crystal panel, and may also be a reflective liquid crystal panel.

In the embodiments, as the imager, a plurality of DMDs are provided. However, as the imager, a single number of DMD may also be provided.

The entire contents of Japanese Patent Application No. 2009-224666 (filed on Sep. 29, 2009), Japanese Patent Application No. 2009-235648 (filed on Oct. 9, 2009), Japanese Patent Application No. 2010-041051 (on Feb. 25, 2010), and Japanese Patent Application No. 2010-042957 (filed on Feb. 26, 2010) are incorporated in the present specification by reference.

### INDUSTRIAL APPLICABILITY

According to the present invention, it is possible to provide an optical unit, a projection display apparatus, and an optical diffuser, which can appropriately achieve speckle noise removal and luminance reduction suppression.

1. A projection display apparatus including a light source that emits light having coherency, an imager that modulates the light emitted from the light source, and a projection unit that projects light emitted from the imager onto a projection surface, the projection display apparatus comprising:
a speckle noise reduction element provided between the light source and the imager; and
a control unit that controls a first mode and a second mode, wherein
the control unit controls the speckle noise reduction element so that speckle noise is reduced in the first mode than in the second mode.

2. The projection display apparatus according to claim 1, wherein
the speckle noise reduction element is an optical diffuser that diffuses the light emitted from the light source and transmit the light emitted from the light source, and
the control unit controls the optical diffuser to diffuse the light emitted from the light source in the first mode, with a diffusion degree higher than a diffusion degree in the second mode.

3. The projection display apparatus according to claim 2, wherein
the optical diffuser has a plurality of diffusion surfaces in a travel direction of the light emitted from the light source, and
the control unit controls the optical diffuser so that the plurality of diffusion surfaces operate in different operation patterns.

4. The projection display apparatus according to claim 3, wherein
the optical diffuser comprises: a first rotating member that rotates about a first rotating axis; a second rotating member that rotates about a second rotating axis parallel to the first rotating axis; and a belt-like diffusion sheet wound around the first rotating member and the second rotating member in an endless loop,
the belt-like diffusion sheet constitutes two diffusion surfaces in the travel direction of the light emitted from the light source, and
the control unit controls the optical diffuser so that the two diffusion surfaces move in a reverse direction according to rotation of the first rotating member and the second rotating member.

5. The projection display apparatus according to claim 3, wherein
the control unit controls the optical diffuser so that when one of the plurality of diffusion surfaces stops, another diffusion surface moves.

6. The projection display apparatus according to claim 3, wherein
the optical diffuser comprises: a first diffusion plate; and a second diffusion plate, and
the control unit controls the optical diffuser so that the first diffusion plate and the second diffusion plate vibrate along directions different from each other.

7. The projection display apparatus according to claim 2, wherein
the optical diffuser has a plurality of diffusion areas with different degrees of diffusion, and
the control unit controls the optical diffuser to diffuse the light emitted from the light source in the second mode, using a diffusion area having a diffusion degree lower than a diffusion degree of a diffusion area used in the first mode.

8. An optical diffuser that diffuses light having coherency and transmit the light having coherency, the optical diffuser comprising:
a first rotating member that rotates about a first rotating axis;
a second rotating member that rotates about a second rotating axis parallel to the first rotating axis; and
a belt-like diffusion sheet wound around the first rotating member and the second rotating member in an endless loop, wherein
the belt-like diffusion sheet constitutes two diffusion surfaces that move in a reverse direction.

9. The projection display apparatus according to claim 1, comprising:
a relay optical unit that relays the light emitted from the light source so that the imager is illuminated with the light emitted from the light source; and
a uniformization optical element, as the speckle noise reduction element, that uniformizes spatial distribution of light intensity on an exit pupil surface of the projection unit.

10. The projection display apparatus according to claim 9, wherein
the uniformization optical element is the optical diffuser provided between the light source and the imager to diffuse the light emitted from the light source while transmitting the light emitted from the light source,
the optical diffuser includes a center area having an optical axis center of the light emitted from the light source, and a peripheral area provided around the center area, and
a diffusion degree of the center area is larger than a diffusion degree of the peripheral area.

11. The projection display apparatus according to claim 9, further comprising: a control unit that controls the uniformization optical element so that the uniformization optical element operates in a predetermined operation pattern.

12. An optical diffuser that diffuses light having coherency and has a diffusion area through which the light having coherency passes, wherein
the diffusion area includes a center area having an optical axis center of the light having coherency and a peripheral area provided around the center area, and
a diffusion degree of the center area is larger than a diffusion degree of the peripheral area.

13. An optical unit comprising:
a pair of lens arrays; and
a vibration applying unit that periodically moves the pair of lens arrays.

14. An optical unit, wherein
the pair of lens arrays comprise: a first lens array with a focal distance f; and a second lens array with a focal distance f′,
the focal distance f and the focal distance f′ satisfies f≦f′, and
when a medium with an absolute refractive index n is interposed between the first lens array and the second lens array, an interval between the first lens array and the second lens array is approximately (f+f)/n.

15. The projection display apparatus according to claim 1, wherein
the speckle noise reduction element is an optical unit that periodically moves so that the light emitted from the light source passes, and
the optical unit includes a pair of lens arrays.

16. The projection display apparatus according to claim 14, wherein
in at least a lens array arranged on an incidence side, of the pair of lens arrays, a diameter d and a focal distance f of each lens are set so that a condition of tan θ<d/4f is satisfied, where θ denotes a divergence angle of light incident upon the optical unit.
